(19) United States
(12) Patent Application Publication
(10) Pub. No.: US 2013/0159165 A1
(43) Pub. Date: Jun. 20, 2013

(54) AUTOMATED PROCESS GUIDANCE APPLICATION AND METHOD FOR CREDIT INSTRUMENT ORIGINATION, ADMINISTRATION AND FRACTIONALIZATION SYSTEM

(71) Applicant: Joanne Marlowe-Noren, Wadsworth, IL (US)

(72) Inventor: Joanne Marlowe-Noren, Wadsworth, IL (US)

(21) Appl. No.: 13/332,304

(22) Filed: Dec. 20, 2011

(51) Int. Cl. G06Q 40/02

(52) U.S. Cl. 705/38

(57) ABSTRACT

A system and method for guiding a user through a complex process are disclosed. The system permits a credit originator as an originating user of the system to enter into, be guided through, and complete a process for the administration, monitoring, quality control and fractionalization of any credit or similar instrument it originates and inputs into the system without such user having substantial knowledge of such process. The system further permits the automated coordination of third party purchasers or investors as participating users of the system to evaluate an originating user's inputs and acquire standardized fractional ownership interests in any credit or similar instrument processed through the system in reliance upon certain preconditions that have been methodically introduced to the system for purposes of the guidance of all users.

### FIELD

The disclosure relates to the automated computer-based systemization and related methods for the originating input, administration, monitoring, quality control, and fractionalization of credit and similar financial products.

### BACKGROUND

Banking institutions and commercial lenders have been the backbone and source of debt capital to the marketplace and have historically kept pace with the increasing needs of a global credit marketplace. The depth and fluidity of the global credit marketplace has grown exponentially during the last thirty-five years due to the introduction of institutional capital to the debt sector, largely through the use of debt securitization and credit bundling practices that have brought institutional investors the opportunity to gain access to the highly lucrative credit marketplace using what was thought to be a scalable, transparent and safe set of derivative based financial tools positioned within a defined and trust-worthy process.

Securitization practices fostered many benefits for institutional investors that were seeking to gain exposure to bank-underwritten or other high-quality credit, both originated on a consumer as well as commercial basis. In a securitization, similar risk-rated credits were grouped together in such a way as to permit the institutional credit buyer/investor to “buy in bulk” without having to assess individual, underlying credit profiles. This practice generated efficiencies that appealed to the institutional investor as credit buyer, and, in general, the securitization methodology for originating, aggregating, selling and managing credit established a fresh-faced economic model that fulfilled a real need for credit products that could be acquired and administered in high-dollar volumes by investors.

Institutional investors grew to depend on what they believed to be a defined and reliable standard process for the origination and administration of credits that they could acquire. Within the context of securitized credit products, an investor could allow banks, financial institutions and lenders to do the job that they did best—originating and underwriting credits—and expect a benefit by placing reliance on those institutions' watchful expertise. The investor did not need to personally manage or service the credits that had been invested in and from which financial gain was achieved, but instead sought to tap into a system that would appoint a trustee to administer those credits and rely on the expertise and warranties of third party credit specialists, rating agencies and underwriters pertaining to the quality of these credit baskets.

Overall, bundled credits that manifested as one of many forms of securitized debt or credit obligations were an exceptional product that created a point of entry for new institutional capital to gain access, exposure and benefit from the credit originated in the marketplace. Securitizations and the derivatives that sprung forth from them were the type of product that, up until recently, had proven to be an improvement in credit distribution, administration and management mechanisms. Their wide-spread use vastly and efficiently expanded the pool of global capital resources that were willing and able to actively support the credit markets because it provided, among other things, bite-sized pieces of credits that the marketplace believed to have been vetted for quality and performance by independent third parties.

In the prior art incarnation of credit-related product administration, monitoring, issuance and distribution systems such as that illustrated by the origination of credit and similar instruments and the issuance and distribution of certain asset-backed securities and derivative products, there was no automated central process and methodology employed that could better guarantee objectivity, consistency, transparency, and the application of a minimum quality standard throughout the market from point of origination to point of a related instrument or security sale to an investor.

For instance, although the delivery of credit through securitization or “credit bundling” shared common operational threads, each investment bank, bank, brokerage firm, or other credit source employed their own proprietary practices to develop their own systems and processes for originating and managing these transactions. The equalizer among the systems was envisioned as the role of the rating agency in its review and rating of the quality of each credit pool. Unfortunately, these varying non-standard systems oftentimes suffered a lack of transparency to the performance of the underlying credit assets, thus, hindering quick and accurate performance evaluations or “spot checks” of the individual components of the securitized bundle as they aged. Moreover, due to a systemic attempt at standardizing the administration and governance of bundled credits through the utilization of an indenture or other like agreement to permit a fiduciary to administer a broad and diverse base of credits more efficiently, the prior art system also failed to provide necessary flexibility for the fiduciary to quarantine or actively manage distressed individual credits as a means to pre-empt or “work-out” pre-default credits before a loss of value would be crystallized.

The foregoing are just an example of a few indicators of the risks to investors when it came to acquiring aggregated credit products through a varied selection of origination, administration and delivery methods consistent with prior-art methodologies. The most prevalent, however, is evident by extension of these indicators when coupled with the lack of a common system to screen, monitor and administer credits. Specifically, because of the de-centralized “originate-bundle-sell” prior art system in which securitized products could, in the pursuit of scalability, become somewhat “detached” from the underlying credits upon which they relied through the application of a variety of derivative-based market approaches, it created an opportunity for credit products to be designed and applied that redressed and retrofitted underlying credits sufficiently to satisfy the high-quality credit demands of institutional appetites. With a system that tolerated lack of transparency and varying administration and governance controls amongst credits, inaccuracies, contagions, an inability to define credit risks, and unfortunately, deception, whether intended or unintended, can manifest.

In light of the foregoing, there was no doubt a historical benefit to the advent of the operation of the prior art systems that both implemented and supported the credit securitization and related derivatives-based instruments in the debt markets. However, these prior art systems contain several limitations that, in the wake of recent economic events, significantly limit their usefulness. Specifically, a loss of investor confidence fueled by a lack of transparency and a related loss of trust in the governance and integrity of credit bundling and underwriting practices is a significant systemic issue that must be actively addressed and overcome.

What is thus needed is a defined, standardized, and highly automated credit origination, administration, monitoring, quality control and fractionalization system and method that guides a user through a plurality of processes to produce fractional ownership interests in each single credit that may be input and processed through the system. Each credit may be supported by collateral comprised of a single asset or a collection of many compatible underlying assets that are visible to the ultimate investor. It is desirable that the system would guide and coordinate the actions of (i) users that are originators of various types of qualifying credits, (ii) users that are administrative services providers that perform certain functions required by the process, and (iii) users that are purchasers or investors in various types of fractional ownership interests in qualifying credits with each such user able to utilize the system and perform the processes efficiently and as intended with reliance on certain guidance and process tools that are made available almost exclusively by an application of the system. Ease of system use, a consistent methodology to the operation of the processes embodied in the system, the definition of a standardized set of source credits to be input and processed through the system, and an ability to guide the user through the process with minimal third party assistance is critical to establishing a uniform, transparent, and well-administered credit origination and administration platform, wherein the credits processed can be modeled into standardized fractional credit ownership interests and delivered to investors using a virtual a straight-through-process methodology.

### BRIEF DESCRIPTION OF THE DRAWINGS

FIG. 1 is a block diagram illustrating an internet-based client/server data portal system that may be employed for a process guidance system.

FIG. 2 is a diagram illustrating the system-based Originating User qualification and enrollment embodiment of the process guidance system.

FIG. 3 is a diagram illustrating the system-based Participating User qualification and enrollment embodiment of the process guidance system.

FIG. 4 is a diagram illustrating the system of on-boarding a Source Credit (as hereafter defined) to the process guidance system.

FIG. 5 is a diagram illustrating the system of assembling, offering and closing a fractionalized Source Credit embodiment of the process guidance system.

FIG. 6 is a diagram illustrating an example of the Source Credit fractionalization and issuance process embodiment of a standard credit-based CPC as enabled through the process guidance system.

FIG. 7 is a diagram illustrating an example of a “funded” Source Credit transaction originated pursuant to a preconditioned method and process embodiment as compatible with the process guidance system.

FIG. 8 is a diagram illustrating an example of an “unfunded” Source Credit transaction originated pursuant to a preconditioned method and process embodiment as compatible with the process guidance system.

FIG. 9 is a diagram illustrating the Source Credit and related CPC maintenance, servicing and monitoring embodiment of the process guidance system.

FIG. 10 is an example of the Source Credit periodic collection, calculation and payment process and method embodiment of the process guidance system.

FIG. 11 is a diagram illustrating a system-based CPC remarketing embodiment of the process guidance system.

### DETAILED DESCRIPTION OF ONE OR MORE EMBODIMENTS

The disclosure is particularly applicable to a client server based process guidance system and method for credit facilities and it is in this context that the disclosure will be described. It will be appreciated, however, that the system and method has greater utility than described below.

### GLOSSARY OF TERMS

Administrative User: a user of the system that is providing predetermined administrative services in support of one or more process steps of the system.

Aggregation Escrow Agent: an Administrative User that is acting as Collateral agent, payments administrator and custodian for certain Collateral-related documents securing a Source Credit.

Borrower: the obligor under a Source Credit.

CPC Class: the category of CPC which is compatible with the system and which results as a result of the fractionalization of a various types of Source Credits upon application of the system processes.

Candidate Originating User: a financial institution, bank or other entity that may seek to qualify as an Originating User of the system, but that has not yet satisfied the preconditions of the system for an Originating User.

Candidate Participating User: any entity that may seek to qualify as a Participating User of the system, but that has not yet satisfied the preconditions of the system for a Participating User.

Collateral: the assets that are pledged in support of and secure a Source Credit.

Collateralized Variable Rate Demand Note (CVRDN): an example of a financial instrument that constitutes a precondition of origination of the type of Unfunded Source Credit that can be fractionalization into one of a variety of enhancement-based CPCs.

Credit Participation Certificate or CPC: a fractional ownership interest in a Source Credit as issued resultant from an application of the plurality of process steps comprising the system.

Electronic Document Execution: a node or software module of the system that permits the electronic execution of documentation generated by the system by one or more users of the system.

Funded Source Credit: a Source Credit wherein the CPC Class resultant from its fractionalization as a result of an application of the processes and method of the system is acquired or purchased by a Participating User with cash funds.

Letter(s) of Credit: the letter(s) of credit which secure the payment of the principal portion of the Notes and that act as the currency for purchase of any fractional interest in an Unfunded Source Credit.

Note: a financial instrument being offered for sale to the institutional capital markets that may be a CVRDN, VRDN or similar instrument as such is a precondition of the establishment of an Unfunded Source Credit.

Note Proceeds: the proceeds derived as a result of the sale and placement of one or more Notes by a Borrower in an Unfunded Source Credit process and method.

Note Trustee: the entity responsible for the administration of the Notes, inclusive of administering the acceptance of Letters of Credit and the release of Note Proceeds.

Originator Reference Number: the identifying number associated with a particular Originating User as assigned as a result of the application of the processes of the system.

Originating User: a user of the system that is acting to originate Source Credits pursuant to predetermined process steps and the method of such system.

Participating User: a user of the system that is qualified to acquire CPCs upon satisfaction of certain preconditions as established in one or more process steps of such system.

Participation Commitment: the commitment to acquire a newly issued CPC as generated by the system on behalf of a Participating User upon such user's request.

Pledged Assets: the assets that are pledged by a Borrower in relation to the Source Credit established in the context of the logical structure of an Unfunded Source Credit.

Purchase Commitment: the commitment to acquire a remarketed CPC as generated by the system on behalf of a Participating User upon such user's request.

Registrar: the entity that acts to record on a book-entry basis or otherwise each Participating User that is a holder of one or more CPCs in a CPC series.

Registered Participant Number: the identifying number associated with a particular Participating User as assigned as a result of the application of the processes of the system.

Retained Interest: an amount of CPCs related to a particular Source Credit that is held by the Originating User that originated such Source Credit.

Servicer: an Administrative User that is acting as the debt servicing agent of a Source Credit.

Source Credit: any credit that qualifies to be on-boarded to the system for purposes of fractionalization as originated by an Originating User.

System Manager: the entity that manages, administers and operates the system.

Trustee: an Administrative User that is acting as a fiduciary agent and trustee, registrar, transfer agent and paying agent (on behalf of the Aggregation Escrow Agent) for a particular CPC series.

Unfunded Source Credit: a Source Credit wherein the CPC Class resultant from its fractionalization as a result of an application of the processes and method of the system is acquired or purchased by a Participating User with a Letter of Credit.

User Verification Process: a node or software module of the system that enables the identification and verification of a User by the system and may include the use of system-assigned user credentials, passwords or biometric identification methods.

Variable Rate Demand Notes (VRDNs): short-term floating rate debt instruments that may be credit enhanced by application of a bank letter of credit or a municipal bond insurance policy.

### DESCRIPTION OF THE SYSTEM AND METHOD

A system and method in the disclosure can be applied to guide a user through a complex process in which the system may automate some defined portion of the process and provide an array of support tools that will permit an understanding of applicable regulatory and jurisdictional rules, system requirements, data inputs, quality control standards, credit criteria and origination processes, and required credit structures and standards that are necessary to support the objectives of the system and individual process modules that, when taken together, embody the system and methods. The system can accommodate and guide specific processes and methods for (i) pre-qualified users that are originating credits and similar instruments (Source Credits) for on-boarding and input to the system pursuant to certain preconditions as determined under a master origination agreement entered with the System Manager (each an “Originating User”), which credits and similar instruments will be thereafter fractionalized into assorted ownership units of defined minimum denominations by the applied processes and methodologies of the system; (ii) pre-qualified users that are investors or purchasers of the fractional direct ownership interests issued in such credits pursuant to certain preconditions as determined under a master participation agreement entered with the System Manager (each a “Participating User”); and (iii) select users that have been independently engaged by the System Manager pursuant to certain preconditions as determined under a master service agreement or other system-compatible professional services agreement entered with the System Manager (each an “Administrative User”). In the context of each such user relationship, the user will be identified by the system each time the system is engaged by such user. The system will associate specific qualification, eligibility, permissions, rights and authorities with each user that will permit such user to be guided through certain automated process steps consistent with the methodology of the system and that particular user's objectives in engaging with the system, such that minimal contact is required with the System Manager or any other user on the system until such time as a decision or input is required from the System Manager, another user required to implement or deploy a particular process step, or such user, and such other user must therefore be drawn in to the process.

The system and method can be used by an originating user to originate and input into the system Source Credits using a logical series of structures that organizes the process into a logical construct of process steps to consistently enable the Originating User to determine if each such originated credit satisfies the underwriting and quality standards required by the system in order to permit the system to fractionalize such credit through the operation of the processes and methods comprising the system. Each component in the logical construct represents a process step and the system guides the Originating User through the logical construct of the system by applying one of a sequence of actions, an iterative process, or a decision matrix. At the time of on-boarding a Source Credit, the system guides the Originating User through a sequence of actions that coordinates with certain pre-determined administrative processes of the system and then draws in select Administrative Users to support the Originating User's determinations and decisions within the context of the logical construct of the system. The coordination of various user types associated with the logical construct of the system may initiate the generation of specific documentation which provides such users with specific direction as to the next process steps required to be engaged by or between the users, inclusive of the entry into agreements by and between specific users or the contribution or input of supporting documentation in support of the objectives of the initiating user. For example, in the qualification of a Source Credit being input into the system by an Originating User, upon the input of credit data via a secured web-based or similar data input portal to required data fields that are displayed to the Originating User as page fragments containing both preconditions applicable to the specific type of Source Credit being input into the system as well as, for example, certain jurisdictional or regulatory requirements that must be observed by the Originating User related to the Source Credit, an automated evaluation of such data will be completed by the system. As a result, an Administrative User will be alerted by the system, for example, a collateral validation agent, to perform such services as have been predetermined by the System Manager with such validation agent, inclusive of the independent verification of the data inputs and information supplied to the system by the Originating User pertaining to the collateral for the Source Credit. Such Administrative User will, upon a satisfactory finding, authorize the system via a secured web-based or similar data input portal to generate a findings letter consistent with a pre-determined standard format of such document that then becomes a permanent addition to the data and information supporting the particular Source Credit that was input to the system by the Originating User.

The system can be further utilized by an Originating User to access a standardized process and logical construct for fractionalizing ownership of each Source Credit that the user inputs into the system in accordance with the guidance provided by the system, whether in the form of guidance pages or automated document generation (each such fractional ownership interest, a “Master Credit Participation Certificate” or “CPC”). The system generates unitized CPCs that are consistently formatted amongst themselves within defined product categories (“CPC Classes”) as derived from the related Source Credit that has been processed through the system resultant from the input of an Originating User. Each Source Credit must satisfy the preconditions established within the context of the system as to quality control, pricing, and any other preconditions imposed by the operation of the processes contributing to the logical construct of the system as such preconditions have been established by the System Manager and accepted by the Originating User as part of the qualification process of each Originating User as an originator of Source Credits that, upon the application of the system processes, will result in the issuance of fractional interests in such Source Credit, wherein such fractional interests are part of a specific CPC Class. For example, outside the logical structure of the system, different Originating Users will observe different underwriting and credit decision criteria in reaching a determination to lend. Based upon certain preconditions established by the System Manager pertaining to each particular type of Source Credit that may be input in to the system to cause the issuance of related CPCs, the system will require specific documentary uploads, automatically display only data fields or page fragments relevant to that type of Source Credit for input and response, and generate only those credit and related documents that are standard and recognized by the system as constituting a part of the construct of a given CPC Class. In this way, each CPC, as constituted by the executed documentation that is generated as various nodes or process steps of the system as the system guides the user through a complex process having a plurality of steps, is consistent as to form, governance terms and administrative conditions and vary only as to commercial terms, pricing and credit-specific conditions. Thus, the system produces a variety of predetermined CPC types that can be grouped into certain system-defined CPC Classes that reflect differing foundational Source Credit characteristics that, when processed through the framework that is dictated by the operation of the nodes of the logical construct of the system, produces highly fungible and scalable fractional interests in qualifying Source Credits in the form of CPCs.

The system guides a Participating User through a process of accessing certain credit data that is gathered by and displayed through the system in an effort to permit such user to reach a decision or determination regarding its desire to acquire one or more CPCs or, alternatively, to monitor on an on-going basis the performance and credit profile of a particular CPC and related Source Credit in which it has acquired an ownership interest. In the context of effecting such decision or monitoring the behavior of a Source Credit or related CPC, the system will generate such images and documents as may be requested by the Participating User regarding each and any CPC series and the related Source Credit and underlying collateral information as gathered and archived by the system in a data repository module resultant from the interface of Originating Users and Administrative Users at each node of the process within the logical construct of the system. For example, the system will determine to display an assortment of CPC Classes to a specific Participating User in accordance with the applicable permissions and qualifications of that particular Participating User as established by the System Manager. Within each such available CPC Class, the system will display a list of specific transactions to a Participating User as identified by designated file reference numbers. The Participating User will select those transactions it has determined to be of interest and gain system access to related transaction descriptions, supporting documentation and related information that has been input into the system by the Originating User for such particular Credit such that a Participating User has sufficient data to make a decision with regard to the selection and acquisition of a CPC issued in such Credit.

The system will only display those CPCs that are permitted by or otherwise consistent with the specific authority to view certain types of transactions that has been granted to such user by the System Manager based upon certain preconditions associated with such user profile at the time such user was permissioned as a qualified user of the system. Such user profile and its corresponding ability to access and view specific transactions may be impacted by, for example, the user's execution of certain standardized risk acknowledgements as may be required by the System Manager pertaining to each specific CPC Class or Source Credit type. The profile of each Participating User will track a variety of data points that will permit the system to automatically reach certain determinations as to that user, inclusive of information such as maximum permitted exposure to CPCs, the identification of authorized personnel of such user that may acquire or commit to hold any CPC product, the user's desired CPC product pricing levels, and any special conditions or restrictions associated with such user as may be predetermined by the operation of the system processes or the System Manager.

Additionally, the system guides each user through a complex process having a plurality of steps and differentiates between the class and profile of user to only display such guidance steps as may specifically apply to such type of user and the particular stage of user interface within the logical structure of the system. The system comprises a logical structure for presenting the steps of the process applicable to such user and the stage and nature of the Source Credit being input and processed through the system. The system further gathers information at each node of the structure, which node constitutes a step in the process, and archives data from each decision and data input from each user and utilizes such inputs and data in the automated generation of documents and reports, Source Credit or CPC statements, payment calculations, documents or agreements for execution by users via the system, and analysis by the system based upon predetermined conditions of analysis, which reports, statements, calculations, documents, agreements, and analysis then comprise a portion of the information supporting the related Source Credit as input by an Originating User and the subsequently associated CPC series that constitutes fractionalized interests therein.

The system fosters the development of a potentially scalable and diverse network of multi jurisdictional Originating Users and Participating Users, which, through the logical construct of the system, potentially aids in standardized underwriting, issuance, administration, monitoring and distribution of CPC instruments that are modeled pursuant to the categorical profile of each Source Credit that has been processed through the system and that provides guidance as to regulatory or similar requirements of operating in, through or from a specific jurisdiction with regard to either a specific user, Source Credit or acquisition of an interest in a particular CPC series. The system enforces certain preconditions applicable to specific types of users to produce a commonality of master terms and conditions that may be applied pursuant to specific regulatory or jurisdictional governance in order to achieve a more universal governance structure for Source Credits and related CPCs. The universal governance of users, Source Credits and CPC within the context of the system constitutes an improvement over prior art credit systems, methods and instruments. For example, an Originating User, as part of the system on-boarding, enrollment and qualification process, is guided through a process that, among other things, requires the user's execution of a Master Origination Agreement with the System Manager that is generated by the system in a form consistent with that which is executed by all other Originating Users. The common execution of such agreement assures that all users are aware of the preconditions to be observed by such user in its specific capacity or relationship to the system. In furtherance of this example, each Originating User will observe a further set of preconditions as established via the execution of a form of system-generated license agreement with the System Manager, setting forth the specific terms, conditions and form of each Source Credit that is eligible to be processed through the system and fractionalized into a specific CPC Class (“License Agreement”), thereby better assuring consistency and better qualify control as to Source Credit and CPCs derived therefrom.

The system incorporates systems and methods for the establishment of new types of credit instruments and related CPCs that, in certain embodiments, rely substantially on the system processes for guidance, administration, monitoring and fractionalization, inclusive of the preconditions established by the System Manager with Originating Users and Participating Users through entry into certain master agreements and License Agreements, and which instruments would be limited in their application or ability to function outside the context of the processes and models inherent in the logical structure of the system. Therefore, the system enables a user to be guided through the processes of the system to originate, monitor or acquire system-specific CPC Classes that may otherwise not be functional or efficient outside the purview of the system.

Thus, specific types of CPCs may not exist in some embodiments except within the logical construct of the processes and methods of the system and constitute an embedded methodology for the origination, administration, monitoring, and fractionalization process of credits or similar instruments and their related CPC series. Likewise, the process of the system and the efficiencies generated by an application of the logical structure of such system may not be enabled or potentially even possible without a standardized, corresponding methodology and logical construct of each type of Source Credit that is eligible to be processed through the system as based upon a series of preconditions and predetermined features that are universally agreed by all system users prior to the application of the apparatus constituting the system.

The system and method is applicable to a process in which a number of users having varying objectives related to their utilization and deployment of the processes embodying the system will access the system through secured and designated web-based or similar access points and be guided and coordinated in accordance with certain preconditions of the system's logical construct in order to achieve the implementation of a system for the processing of Source Credits that (i) standardizes credits and related quality control measures to improve scalability, (ii) enhances transparency to underlying credit details, data, performance, risk profiles, and collateral validation and status, (iii) improves administrative efficiencies in credit monitoring, servicing, and payments, (iv) imposes third party governance mechanisms based upon certain preconditions of system operations, (v) enhances originator accountability and performance-linked reporting; (vi) produces a highly automated and repeatable process for the fractionalization of Source Credits input through the system and the direct fractionalized ownership of such Source Credits without the introduction of prior art derivative products or securitization methodologies, (vii) expands the base of potential investors that are governed by standard preconditions of the system and therefore prequalified to acquire fractional credit interests in the form of CPCs as produced as a result of the application of the processes of the system; and (viii) increases credit market liquidity through the issuance of highly fungible fractional interests in Source Credits in a consistent manner as such may be readily categorized into specific CPC Classes.

The system and method guides an Originating User through a complex, multiple step process for the administration, monitoring, quality control and fractionalization of any Source Credit that the Originating User originates and inputs into the system without such user having substantial knowledge of such process. The system also enables the automated coordination of third party purchasers or investors as Participating Users to evaluate an Originating User's Source Credit inputs and acquire standardized fractional ownership interests in the form of CPCs in reliance upon certain preconditions that have been methodically introduced to the system for purposes of the guidance of all users. By employing the system and methods, an Originating User is able to administer, monitor, and maintain each Source Credit input into the system and is able to be guided through the system to permit the fractionalization of such credit into a particular type of CPC, which may then be displayed with all archived and gathered data, documentation, agreements, reports and statements related to such CPCs to Participating Users as a precursor to a Participating User's acquisition of such CPC or at anytime thereafter as a means of providing standardized and enhanced transparency to the behavior and performance of such Source Credit or related CPC series in issuance.

The system enables certain professional service providers and regulated and/or other entities required in support of the processes as Administrative Users to receive automated system alerts generated by the system and to access the system through designated web-based portals or similar designated points of system entry as a means and method for delivery of such services as and when required by the processes of the system. The system generates documents to enable the coordinated performance of support services by Administrative Users based upon certain predetermined document formats and conditions as enabled by the system's retrieval of gathered and archived data related to each Source Credit and related inputs of the Originating User and other Administrative Users.

The system chains together processes within a logical structure that enables the automated performance of process steps by the system in coordination with process steps to be performed by either Originating Users, Administrative Users, or Participating Users to cause the fractionalization of subject Source Credits that are input into the system by an Originating User. The system enables the semi-automated processing and issuance of CPCs in conformance with system-generated standardized documentation templates applicable to each specific type of CPC as such documentation reflects data and decision inputs from each type of user that is engaged in the system process steps at each node of the logical construct. The system also provides for the automated delivery of such CPC data and documentation in response to certain decisions made by a Participating User in such user's selection of a CPC series for purposes of acquisition or purchase as that user determines and, thereafter, enables on-demand access by or system-generated alerts delivered to each such user comprising Source Credit performance details, reports, credit monitoring, payment calculation and status. Thus, based upon such enhanced system-generated data and information access flows, the CPCs issued and generated based upon the system raise placement efficiencies and create a foundation in the marketplace that is conducive to the volume placement, sale and remarketing of CPCs.

### EXAMPLE

For the purposes of explanation and not to narrow the scope, in the following examples and diagrammatic representations of select processes comprising the system, a fractionalization interest in a Source Credit that is processed through the system can be referred to as a Credit Participation Certificate or CPC. For the purposes of explanation and not to narrow the scope, in the following examples, although all fractionalized Source Credits resultant from the application of the processes comprising the system are described within the context of certain types of credit instruments (e.g. Credit Participation Certificates or CPCs), it will be appreciated, however, that the system has greater utility, such as in equity-based transactions, bonds or other prior art instruments or securities that could be administered, monitored, fractionalized, processed, archived and displayed to other users through the application of the logical structure of the system. For example, the system may be used to guide a user through an administration, monitoring, quality control, and fractionalization process of a standardized convertible bond transaction, wherein, both credit and equity components are features of the source input by an Originating User and the system output of fractionalized interests reflecting the characteristics of such source input may not be solely or most accurately described as a “credit” participation certificate. Nonetheless, the utility of the system will have generated such output upon application of the guidance, administrative, monitoring, quality control, and fractionalization processes comprising the system. By way of further example, segments of the system may be applied to guide users in relation to other industries, transactions and source inputs for purposes of achieving only a portion of the performance objectives of which the system is capable.

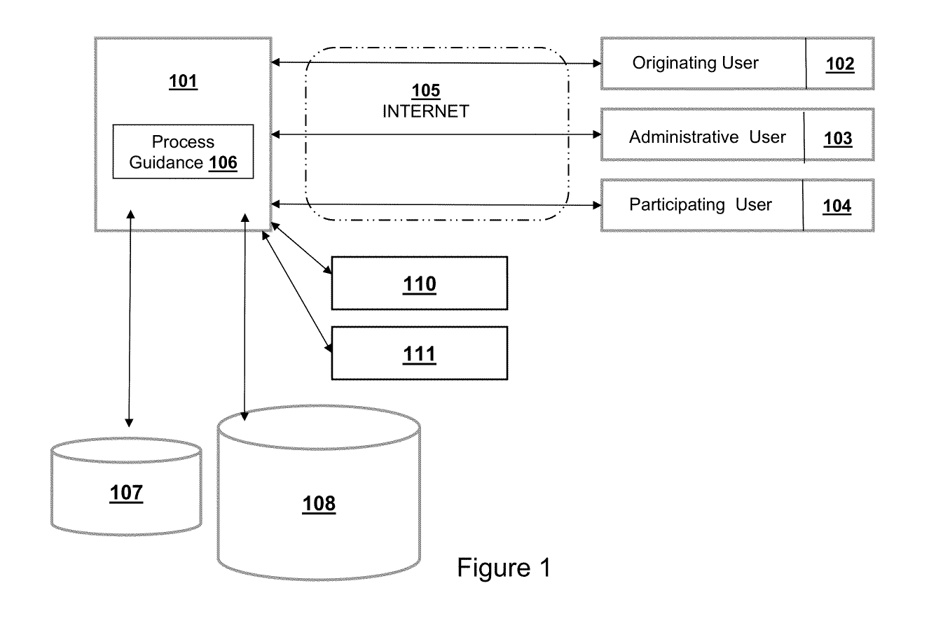

Referring first to FIG. 1, a block diagram illustrating an internet-based client/server data portal system of the type that may be employed is seen. The computer system may be a hosted server-based system and may include a central unit (101) that may be accessed via secured web-based internet portals 102-104 as well as a credit portal 110 and a lending portal 111 over a link 105, such as the Internet in one implementation. The central unit 101 may be implemented as one or more server computers that have the typical components of a server computer. The modules and units of the central unit 101 that perform the processes described below may be further implemented as plurality of lines of computer code executed by a processing unit of one or more server computers, but the central unit may also be implemented in hardware.

Each portal is designed to accommodate the specific system requirements of either (i) Originating Users (102), (ii) Administrative Users (103), and (iii) Participating Users (104), and the system will permit multiple users in each category concurrently to exchange objects and access the data (105) gathered in data repository component of the system in accordance with specific permissions assigned by the System Manager and based upon certain preconditions associated with each such user. Each of the portals 102-104, 110 and 111 may be implemented as a computing device having a processing unit, a memory connected to the processing unit and a display that is capable of interacting with the central unit. For example, each computing device may be a personal computer, a tablet computer, smartphone device (Apple iPhone, RIM Blackberry, Android based device, Nokia device and the like), a terminal or a cellular phone.

In one embodiment, although alternative system integrations could be possible, the computer system would be a thin client system in which the central server contains most software applications being executed and employed in the processes of a process guidance unit 106 of the system, links to or otherwise accesses a data repository integrated into the computer system containing the data gathered through the application of the process steps comprising the system (107), and the client computers may execute a browser-based application that interacts with the central server system software. The system may also have a data repository 107 that may be implemented as software or hardware based databases that stores the various data used by the system as described below. The system 106 may also have a credit processing and fractionalization unit 108 that processes the incoming source credit and fractionalizes the source credit as described below in more detail.

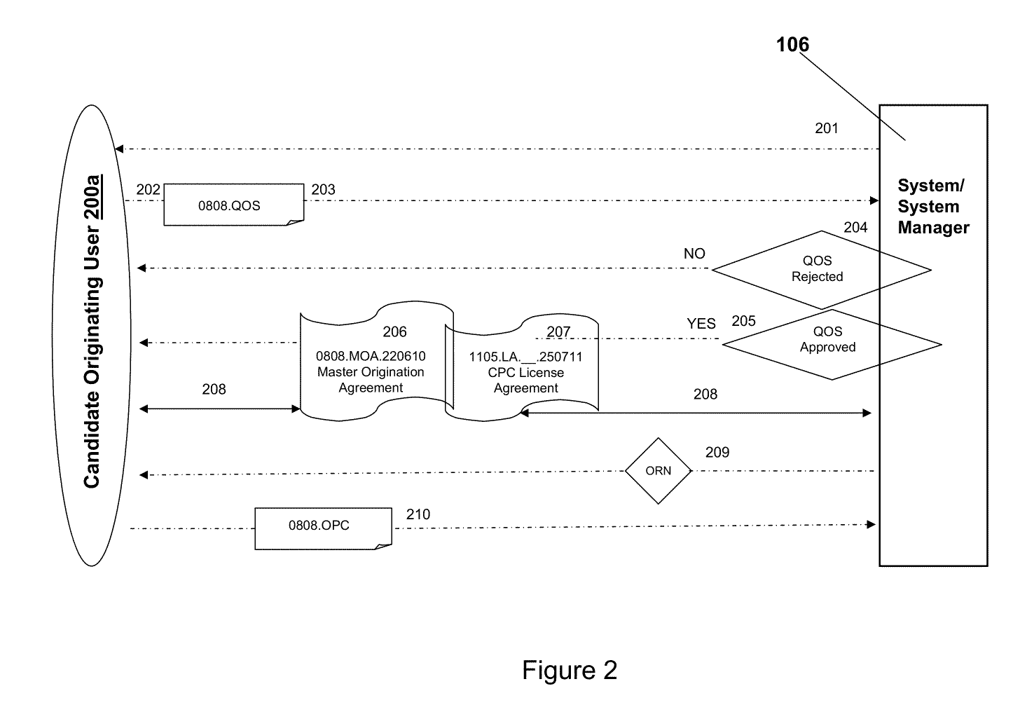

Referring now to FIG. 2, a diagram illustrating the system-based Originating User qualification and enrollment process implemented by the process guidance system of FIG. 1. In the present example, a candidate Originating User (Candidate Originating User) is sited and the process steps of the system identified that defines the preconditions established by the System Manager for each and every Originating User of the system. The process steps identified specifically defines certain decisions required for the qualification of such user as a prerequisite to granting such Candidate Originating User the applicable system and security permissions to access and be guided through the system for purposes of inputting one or more Source Credits into the system.

Once a Candidate Originating User has been identified by the System Manager, the System Manager will assign certain user-specific security credentials that will enable the system to authenticate such candidate user. Based upon those permissions, the Candidate Originating User will access certain guidance pages via the originating user client portal. The guidance pages may be comprised of certain page fragments that call for the input of certain data to be gathered or user decisions or choices to be made as a precursor to the display of the next page fragment responsive to that particular user's inputs (e.g. yes/no, notice address, authorized personnel, licensing or regulatory oversight agencies, etc). The process of the system may cause the page fragments to dynamically respond or change based upon the data inputs of the user as the user navigates the process steps of the system. In this example, the process and method of Originating User qualification under certain preconditions of enrollment as a user of the system as established by the System Manager calls for the system's generation of a Qualified Originator Statement, comprised of multiple data field input points and page fragments that will generate and display to the Candidate Originating User via the system portal. The generation of such Qualified Originator Statement may constitute a root node (201) in the qualification process, which is the initiation of the exchange of objects between the system and the Candidate Originating User.

Upon the Candidate Originating User's responsive data inputs (202), the system will guide the user through such process steps to enable the electronic execution or signature of the Qualified Originator Statement via an integrated software application containing user identifiers sufficient to authenticate the electronic document execution process (Electronic Document Execution) and the automated delivery (203) thereof to the System Manager. The system may call for the electronic execution of documents at various decision points and or process nodes embedded in the logical structure of the system based upon the nature of documents generated by the system or input by the System Manager or another user. As illustrated, the system will request a decision from the System Manager as to its approval or rejection of the Candidate Originating User's qualifying data inputs (204). For the purposes of example, in the event the System Manager approves (205) the Candidate Originating User, the system will generate certain legal documents and agreements pursuant to certain predetermined formats in reliance upon the Candidate Originating User's data inputs as archived by the system which comprise the preconditions of the operation and qualification of an Originating User within the context of the system. Specifically, the system will generate a (i) Master Origination Agreement (206) and (ii) a CPC Class-specific License Agreement (207), reflective of the type of Source Credits proposed to be originated by the Originating User via the application of the system and alert the Candidate Originating User of the awaited Electronic Document Execution. In the processes of the system, the user may at certain nodes of the process be permitted to request or otherwise negotiate a modification of terms and conditions of select agreements being presented for Electronic Document Execution through the system. In this example, the terms and conditions of the License Agreement may be subject to modification or negotiation via a system-driven dialog between the user and the System Manager, however, generally in the case of a master agreement generated through the system, the terms and conditions are not subject to modification or negotiation since the processes of the system relies on standardized preconditions of origination and, ultimately, fractionalization of Source Credits as a means of achieving enhanced efficiencies and consistency of the fractionalization processes of the system.

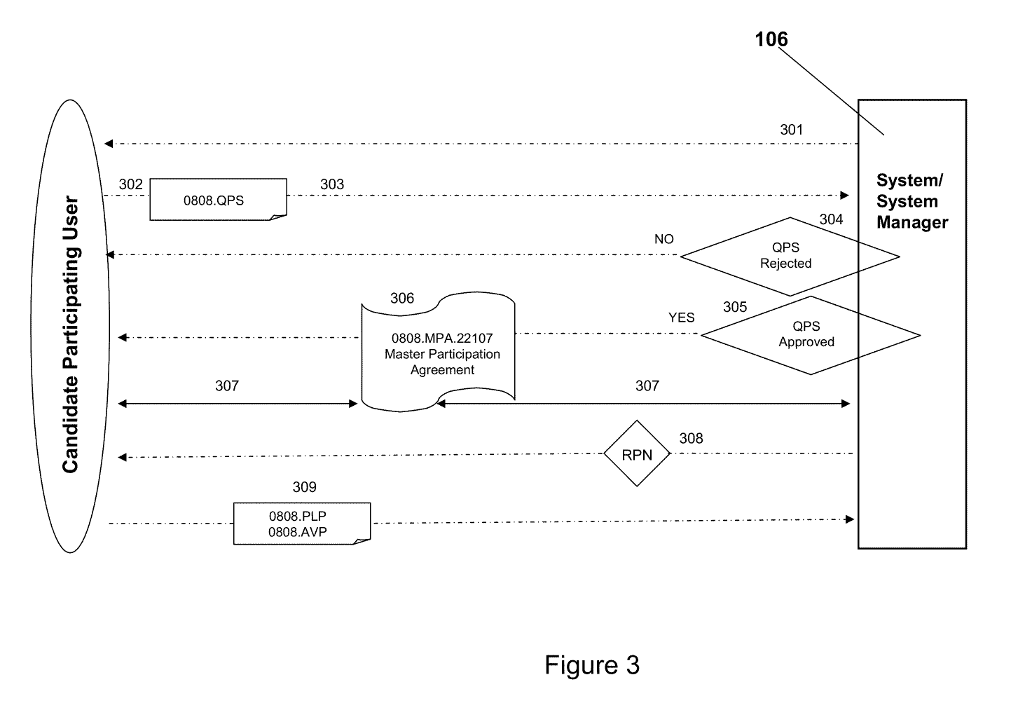

Provided the aforementioned agreements have been mutually executed (208) via the Electronic Document Execution process (such as the Docusign system or the Silanis system), the system will extract certain data points from the executed agreements in order to automatically assign (209) an Originator Reference Number to the Candidate Originating User, which, as of such assignment, is now designated as a qualified Originating User, having such recognized credentials and permissions as the preconditions of the agreements executed with such Originating User will permit. Concurrent with the assignment and delivery notification of the Originator Reference Number, the system will generate (209) an Originator Profile and Consent form for completion and Electronic Document Execution (210) by the Originating User, permissioning the system to publish and make available information regarding the Originating User to other qualified users of the system, inclusive of such Participating Users that may request access to such data and information, upon the fractionalization and availability of any Source Credit originated and input into the system by such Originating User that is then being considered for acquisition by a Participating User. Now, similar to the processes set forth for Originating Users, the preconditioned qualification process for Participating Users of the system is defined in FIG. 3.

Referring now to FIG. 3, a diagram illustrating the system-based Participating User qualification and enrollment embodiment of the process guidance system is seen. In the present example, a candidate Participating User (Candidate Participating User) is sited and the process steps of the system identified that defines the preconditions established by the System Manager for each and every Participating User of the system. The process steps identified specifically define certain decisions required for the qualification of such user as a prerequisite to granting such Candidate Participating User the applicable system and security permissions to access and be guided through the system for purposes of reviewing, acquiring, monitoring, or acquiring CPCs resultant from the input of one or more Source Credits into the system by Originating Users.

Once a Candidate Participating User has been identified by the System Manager, the System Manager will assign certain user-specific security credentials that will enable the system to authenticate such candidate user. Based upon those permissions, the Candidate Participating User will access certain guidance pages via the Participating User web-based access portal. The guidance pages may be comprised of certain page fragments that call for the input of certain data to be gathered or user decisions or choices to be made as a precursor to the display of the next page fragment responsive to that particular user's inputs (e.g. types of credit acquired, geographic footprint, true/false, etc). The process of the system may cause the page fragments to dynamically respond or change based upon the data inputs of the user as the user navigates the process steps of the system. In this example, the process and method of Participating User qualification under certain preconditions of enrollment established by the System Manager calls for the system's generation of a Qualified Participant, comprised of multiple data field input points and page fragments that will generate and display to the Candidate Participating User via the system portal. The generation of such Qualified Participant Statement may constitute a root node (301) in the qualification process, which is the initiation of the exchange of objects between the system and the Candidate Participating User.

Upon the Candidate Participating User's responsive data inputs (302), the system will guide the user through such process steps of the system to enable the Electronic Document Execution of the Qualified Participant Statement and the automated delivery (303) thereof to the System Manager. As illustrated, the system will request a decision from the System Manager as to its approval or rejection of the Candidate Participating User's qualifying data inputs (304). For the purposes of example, in the event the System Manager approves (305) the Candidate Participating User, the system will generate certain legal documents and agreements in reliance upon the Candidate Participating User's data inputs as archived by the system which comprise the preconditions of the operation and qualification of a Participating User within the context of the system. Specifically, the system will generate a Master Participation Agreement (306), and alert the Candidate Participating User of the awaited Electronic Document Execution. In this example as well as that of FIG. 2, the terms and conditions of the master agreement generated through the system are not subject to modification or negotiation since the process of the system application relies on standardized preconditions of fractionalization of Source Credits as a means of achieving enhanced efficiencies and consistency of the fractionalization processes of the system.

Provided the aforementioned agreements have been mutually executed (307) via the Electronic Document Execution process, the system will extract certain data points from the executed agreements in order to automatically assign (308) a Registered Participant Number to the Candidate Participating User, which, as of such assignment, is now designated as a qualified Participating User, having such recognized credentials and permissions as the preconditions of the agreements executed with such Participating User will permit. Concurrent with the assignment and delivery notification of the Registered Participant Number, the system will generate (i) a Participating Lender Profile and (ii) an Authority to View and Participate in Transactions (309) by the Participating User, both of which are subject to Electronic Document Execution via the system. Against receipt of these executed documents, the system will thereafter generate and deliver alerts to the Participating User with reference to then available CPC series that conform to the Participating User's standards and also will assign access authority to only those authorized representatives of the Participating User that have been authorized by such Participating User to access data and information and/or acquire CPCs via the participating user system portal. Now, an example of how a credit is on-boarded and input into the system by an Originating User for subsequent consideration by a Participating User will be described.

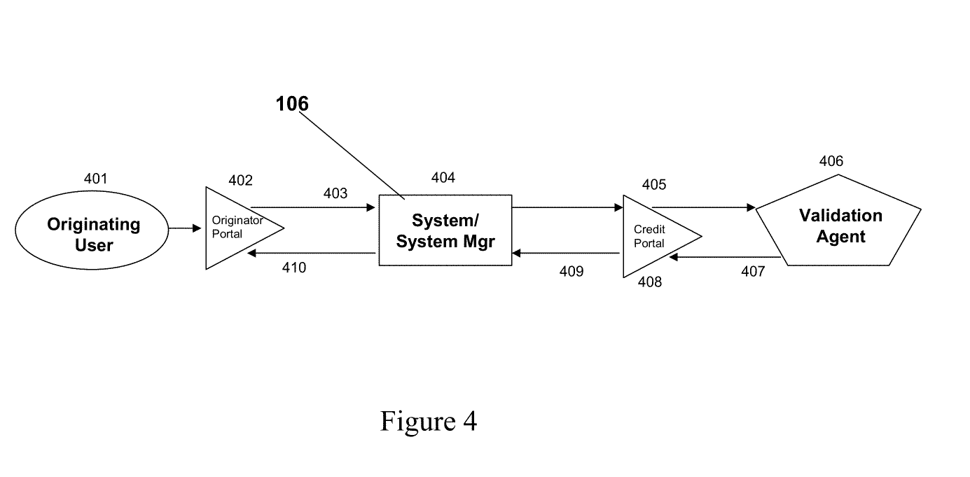

Referring now to FIG. 4, a diagram illustrating the system of on-boarding a credit to the process guidance system is seen. In the present example, an Originating User that has met and satisfied the preconditions of the system processes described in FIG. 2 is sited. The apparatus for guiding a user through multiple process steps is provided that defines an overview of the logical structure of the system based upon a logical construct of steps wherein each process step is represented by a node of the structure. At varying steps in the process, alternatives are presented to the user requiring the user to input responsive data or information or to make a decision. The system also comprises a database component that permits all responsive data that is recorded as a page fragment to be gathered from related and unrelated users at each respective and applicable node of the system to be archived and retrieved by the system wherein such page fragment can be utilized as a precondition to the system generation of guidance pages, documents, agreements, or other informational requests generated by the system as part of its logical construct for display, access or Electronic Document Execution by a user. The process described in FIG. 4 commences upon the system's identification and authentication of an Originating User that satisfies (401) the preconditions of acting as a transaction originator to the system as described in FIG. 2 by cross-referencing the assigned Originator Reference Number, the authorized personnel and taking such other predetermined security and authentication measures as may be defined by the system processes for any user, inclusive of biometric identifiers, reconciliation of authorized IP addresses, and credentialed access as may be adopted by the System Manager from time to time (User Verification Process).

In the present example, the Originating User initiates the system process by activating a root node that constitutes the initial process step in the logical structure that represents the process of Source Credit input or “on-boarding” to the system such that other users may engage in the process at subsequent nodes wherein guidance pages, documents and agreements may be generated by the system in reliance upon data fragments derived from the Originating User's actions at time of Source Credit input. In this particular system process, the page fragments constituting the Source Credit details (e.g. credit type, class of CPC generated upon fractionalization, maturity, rate, etc.), inclusive of a CPC category node requiring the Originating User to select what particular CPC Class the Source Credit will apply to if accepted by the system and thereafter fractionalized as a result of the application of the system process, are input (402) by the Originating User and relied upon in the subsequent construct of guidance pages, documents and agreements as required by the logical structure of the system throughout the balance of the related processes of the present example as well as other transactionally related system functions, such as servicing, monitoring, payments, fractionalization, and purchases/remarketing that are performed by the system during the lifecycle of the Source Credit. At this node, the system will automatically generate (403) an Originator Document Certification warranting the correctness, truthfulness and accuracy of Originating User inputs related to the Source Credit and a Credit Contribution Certificate, legally assigning the particular Source Credit represented by the Originating User inputs to the System Manager or, as the case may be, the designated assignee of the System Manager that will act as the issuer of the related CPCs. The system will require as a precondition to the performance of subsequent process steps by the system and the application of related page fragments to the generation of subsequent documents, inclusive of alerts related to the Source Credit, that both of these system-generated documents be subject to the Electronic Document Execution process application of the system.

Upon the completion of the Originating User inputs, the system will automatically apply (404) a predetermined quality control matrix to the page fragments representing the Source Credit details to verify that (i) the Source Credit satisfies certain preconditions as to completeness, accuracy, mathematical analysis and satisfaction of minimum predetermined transaction ratios, and consistency with documentary support as uploaded in the form of images in accordance with the process related to a Source Credit, and (ii) the particular Originating User that has input such Source Credit is duly authorized under a related License Agreement as entered with the System Manager to so do. The system, by passing the page fragments through single or multiple nodes representing quality control stations in the logical construct, may apply certain software applications to the performance of all required structural components of the processes of the present example, such as image recognition technologies for purposes of comparing data contained on pdf or imaged documentation with associated and responsive page fragment data captured by the system, underwriting software containing industry-specific and applicable mathematical formulas, and document administration and management software processes to assure completeness of the Source Credit submission when compared to predetermined documentary components of the CPC Class related to which the particular Originating User is authorized to act under predetermined License Agreement terms in the origination and on-boarding of related Source Credits in accordance with the processes. Predicated upon the satisfaction of the conditions of the quality control check, an alert will be initiated by the system via electronic mail or other similar communication methods to a designated specific Administrative User. The Administrative User will, upon satisfactory completion of the User Verification Process, access the system via a web-based administrative portal and be requested (405) by the system to perform certain predetermined Source Credit validation processes as previously established by the System Manager and such Administrative User. The validation process will call for an independent verification by the Administrative User of certain page fragments and data inputs archived by the system related to the subject Source Credit as such has been displayed by the system to such user. The Administrative User will perform (406) such validation processes as had been predetermined by the System Manager related to the specific CPC Class applicable to the Source Credit upon fractionalization by the system. The nature of validation processes will vary based upon System Manager requirements, but by way of example and not limitation, scheduled processes may include the independent verification of collateral, security interests, historical performance claims, and/or UCC filings pertaining to the Source Credit. Upon completion of the system-prescribed validation processes, the Administrative User will be guided through a process to input (407) information in response to the system's presentation of certain guidance pages reporting on the Administrative User's independent validation findings process as applicable to the associated Source Credit.

The page fragments comprising the findings of the Administrative Agent will be applied by the system processes to generate (408) a Findings Letter that will be subject to the Electronic Document Execution software application by such Administrative User. Upon execution, the system will contribute (409) an image of the executed Findings Letter to the Source Credit File as established in the data repository module and issue an alert (409) to the System Manager for purposes of the System Manager's access of the system in order to engage in the Electronic Document Execution of the Originating User's Credit Contribution Certificate, confirming the suitability of the Source Credit for processing through the system. The executed (electronically countersigned) Credit Contribution Certificate constitutes the System Manager's legal acceptance of the assignment of the Source Credit and the commencement of the system process steps required for the fractionalization of the Source Credit into a related CPC series and is automatically delivered (410) to the Originating User by the system in confirmation of the same.

Although not illustrated in the present example, at either of steps 404 or 406, had the automated quality control nodes or the independent verification of any predetermined aspects of the Source Credit been deemed unacceptable, rejected, disapproved, or otherwise unsatisfactory in accordance with certain preconditions of the system or predetermined standards established by the System Manager with the Administrative User, inclusive of the possibility that the credentials of any user did not permit or sufficiently authorize such user to perform the functions performed or to act in response to a request from the system under the logical construct of the system as constituted by one or more process steps or related to any aspect of the processing or input of the Source Credit, the system may alert the Originating User, identifying that page fragment or other data or input which was found in error or otherwise unacceptable. In response and within the context of an embodiment, the Originating User will have the opportunity to dynamically amend any page fragments found to be unacceptable or inconsistent with any portion of the other page fragments or data gathered related to the Source Credit. The applicable ensuing process steps embodied in the logical construct of the system will be repeated until such time as the system establishes that the Source Credit is sufficient or satisfactory within the context of system preconditions to support the operation of further nodes representing process steps of the system that rely upon Source Credit inputs, document generation, and related execution of agreements as described in steps 401 though 410. Now, the process for assembling a qualified Source Credit that satisfies all quality control preconditions of the system will be described.

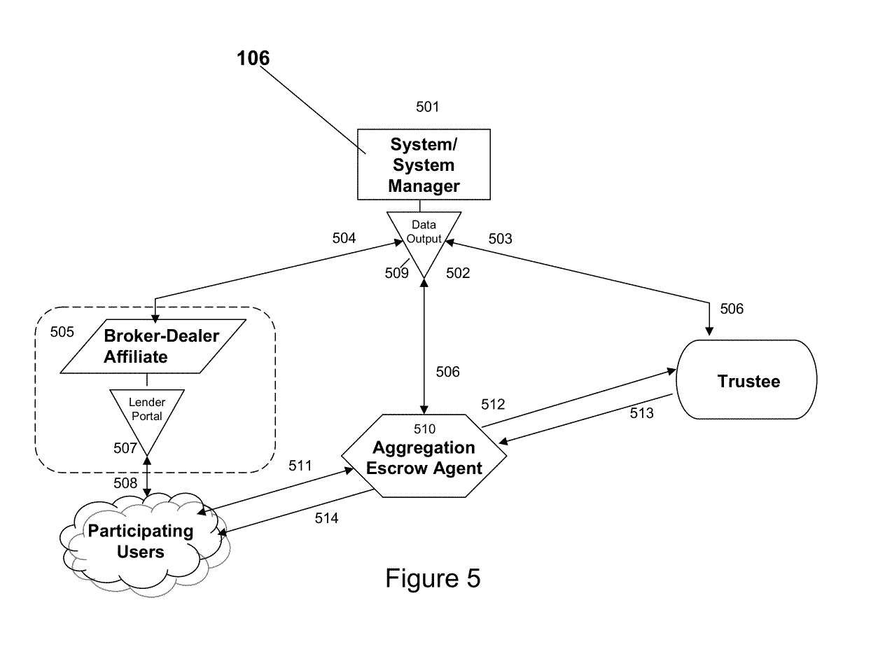

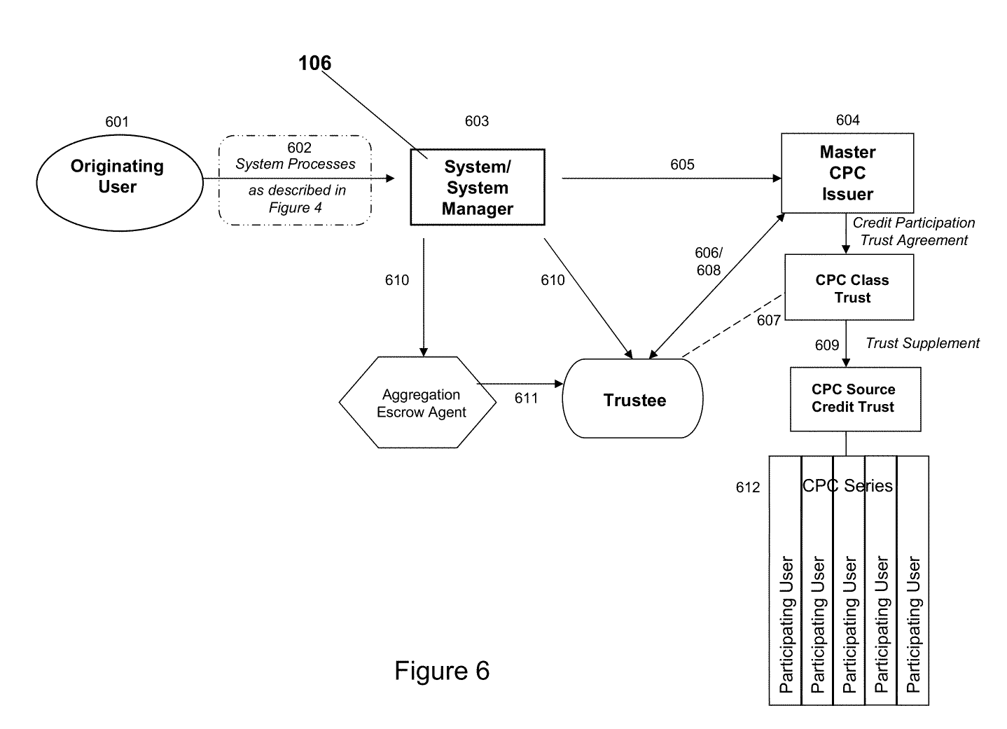

Referring now to FIG. 5, a diagram illustrating the system of assembling, offering and closing a fractionalized Source Credit embodiment of the process guidance system is seen. Carrying forth the example sited in FIG. 4, upon the acceptance of the assignment of the Source Credit pursuant to the system processes for on-boarding, all data inputs, document inputs, quality control findings, and related Source Credit page fragments will have been gathered and stored in the system data repository, inclusive of the applicable CPC Class. As an elaboration on the logical structure constituting the system, the system will determine based upon CPC Class-specific preconditions what page fragments apply to the assembly of descriptive documentation to be generated by the system related to information to be presented to Participating Users pertaining to the CPC Class to which a particular Source Credit will relate once fractionalized through the application of the processes in one embodiment. For the purposes of example and not limitation, there are a variety of system-reliant CPC Classes derived from the application of an embodiment, such as (i) State Receivables CPC, (ii) Government Receivables CPC, (iii) Trade Receivables CPC, (iv) Asset-Backed Insurance Credit or “ABIC”, (v) Commercial CPC, (vi) Commercial Enhancement CPC, (vii) Bank Portfolio CPC, (viii) Portfolio Enhancement CPC, (ix) Aggregation CPC, (x) Aggregation Enhancement CPC, (xi) Private Equity CPC, (xii) CPCPC, (xiii) Fund Enhancement CPC, (xiv) Special Enhancement CPC, (xv) Mezz CPC, (xvi) FlexCPC, and (xvii) Mezz Enhancement CPC, all of which share common approaches to the fractionalization methodologies employed by the system (as depicted in FIGS. 6, 7, and 8), but many of which are reliant upon the system-specific logical construct of the process steps, defined Source Credit criteria and characteristics, process and user preconditions, System Manager predeterminations in the form of standards, guidelines, and governance, and the comprehensive logical structure of the process guidance system, inclusive of its document generation, administrative systems, quality control nodes, and fractionalization methodology; all as embodied in the system to enable the consistent and standardized operation of all CPC units within the context of the system.

The Source Credit information gathered by the system will be applied by the system to generate (501) transaction specific documentation to be displayed via one or more administrative or participating user web-based data portals to, as the case may be, (i) Administrative Users for purposes of enabling the Source Credit maintenance, collateral administration, custodial services, and fractionalization processes, and (ii) Participating Users that have satisfied such preconditions as set forth in FIG. 3 to qualify or otherwise be recognized by the system as accredited for purposes of viewing a particular Source Credit and dealing in the applicable CPC Class derived from the system-based fractionalization thereof. For illustration purposes in the present example, the system will generate and display (a) to an Administrative User (502) that has been predetermined by the System Manager to act in the capacity of an Aggregation Escrow Agent (wherein such entity is required to act as collateral agent for the Source Credit and administrator of CPC proceeds, among other duties) in order to support the systematized fractionalization of the Source Credit transaction, a transaction-specific Aggregation Escrow Agreement and Collateral Schedule, each consisting of such appropriate data inputs and page fragments as to complete the legal document template applicable to such CPC Class as would be associated with the nature of the subject Source Credit; (b) to an Administrative User (503) that has been predetermined by the System Manager to act in the capacity of Trustee (wherein such entity is required to act as custodian and trustee for the Source Credit and administrator of the related CPC issuance, among other duties) in order to support the systematized fractionalization of the Source Credit transaction, a transaction-specific Credit Participation Trust Supplement (upon satisfaction of such preconditions as set out in FIG. 6) and form of Participation Certificate, each consisting of such appropriate data inputs and page fragments as to complete the legal document template applicable to such CPC Class as would be associated with the nature of the subject Source Credit; and (c) via an Administrative User acting in the capacity of a master placement agent for CPCs, to such Participating Users as may be predetermined to be authorized to view such data (504), a form of New Deal Summary that describes the CPC series that is to be derived from the associated subject Source Credit and is comprised of multiple page fragments, wherein those fragments are assembled in such a way as to subscribe to a standard format reflective of such characteristics as is appropriate for such CPC Class. In one embodiment, the CPC series data, such as the New Deal Summary and Credit Participation Offering (as defined in process step 507 below) will be delivered via a participating user portal that is owned and operated by a duly registered, regulated and/or licensed entity (505) having such professional credentials as may be required to permit the offering or solicitation for sale of securities in a form consistent with the CPC Class applicable to the Source Credit as such CPCs have been derived from the application of the system.

The agreement generated under steps 502 will be subject to mutual Electronic Document Execution by the System Manager and Aggregation Escrow Agent in accordance with the logical construct of the system. The agreement generated under steps 503 will be subject to mutual Electronic Document Execution by the applicable parties in accordance with the logical construct of the system and only upon the satisfaction of certain preconditions associated therewith as further defined in FIG. 6. Upon full execution, such documents will be gathered and recorded (506) in the Source Credit File as maintained in the data repository module of the system. The applicable page fragments and all imaged support documentation and agreements, inclusive of the Aggregation Escrow Agreement and Credit Participation Trust Supplement, will be accessed and compiled by the system into a Credit Participation Offering of the specific CPC series derived from the fractionalization process within the system as such has been applied to the Source Credit. The Credit Participation Offering will contain a fragment precondition to display (507) only to those Participating Users that are qualified to receive such information pursuant to system credentials and authorities. Based upon a review of the system data via guidance pages containing the applicable CPC series data points, a decision will be requested of each Participating User (e.g. to participate or not to participate in the subject transaction) and each Participating User will input data and decision (508) via the participating user portal for capture by system. In the present example, we are illustrating a decision taken and input as a page fragment by the Participating User to acquire a fractional interest in the Source Credit in the form of a CPC. As such, the page fragments and data inputs gathered by the system through the participating user portal will be coordinated (508) by the system into a Participation Commitment that will be subject to Electronic Document Execution by the Participating User and deposited to the system data repository.

Through the operation of a data aggregation node within the logical construct of the system, a Participation Schedule will be generated by the system based upon the data fragments contained in each Participating User's Participation Commitment as submitted for a specific Source Credit and related CPC series. The Participation Schedule will be displayed and delivered (509) to both the Aggregation Escrow Agent and the Trustee. The data aggregation node will have provision for the management and administration of a variety of contingent outcomes of such data aggregation, inclusive of tracking over-subscriptions and under-subscriptions and recognizing non-qualifying Participation Commitments. For example, in the case of an over-subscription, provision may be made by the system to those Participating User's that were unsuccessful in a specific CPC subscription by giving preference to such Participating Users in the event of a further scheduled advance under such Source Credit, wherein additional CPCs of that same series may be subsequently issued. Similarly, the system could provide for preference in the offering of the next series that may be issued and available in that same CPC Class.

In response to the availability of the Participation Schedule and a request for the generation of both a (i) Confirmation of Collateral Custody and (ii) Notice of Closing as input to the system by the Aggregation Escrow Agent, the system will automatically generate the requested documentation on behalf of the Aggregation Escrow Agent and display such to the Aggregation Escrow Agent for Electronic Document Execution (510). An image of the electronically executed documents will be deposited to the Source Credit File in the created in the data repository module of the system. The system will generate an alert to each Participating User listed on the Participation Schedule and the Trustee. The Confirmation of Collateral Custody, accompanied by an image of the electronically executed Aggregation Escrow Agreement governing the collateral and payments related to the subject Source Credit and related CPC series will display and deliver (511) to each such Participating User, while the Notice of Closing will display and deliver (512) solely to the Trustee. The display and delivery of the respective documentation identified will be accompanied by specific guidance pages that will identify the next action required by the recipient of the documentation, specifically, (a) in the case of the Participating Users, the amount and date of issuance of the Source Credit related CPC series, which date will also be the scheduled closing date of such CPC series and the date that each respective amount of funding proceeds is required to be deposited with the Aggregation Escrow Agent by each respective Participating User (Funding Proceeds), and (b) in the case of the Trustee, will input such data in the form of page fragments to define the CPC series being issued, inclusive of the CPC series number, each respective CPC number, the Participating User's name in which the applicable certificate will be issued on the closing date, the face value of each CPC, and such other preconditions as may be identified or specific information as may be requested for action by the Trustee, and such page fragments shall be compiled (513) by the system into a CPC Issuance Schedule. The CPC Issuance Schedule will be subject to Electronic Document Execution by the Trustee and displayed and delivered to the Aggregation Escrow Agent. For purposes of example, the CPC Issuance Schedule will contain such data and information as is customarily recorded in the register of an institution acting as Registrar for a security series. Additionally, as a precondition to the generation, execution and delivery of the CPC Issuance Schedule, the Trustee will have taken such actions as provided by guidance pages of the system as described in steps 606 through 609 of FIG. 6, wherein such steps guide the Trustee through the fractionalization of the Source Credit and administrate the issuance of the CPCs constituting the CPC series related to the subject Source Credit on the date set forth in the associated Notice of Closing.

Upon the Aggregation Escrow Agent's receipt of such CPC Issuance Schedule and in accordance with a specific guidance page that contains fragment preconditions that must be satisfied prior to the Aggregation Agent taking such action as may be described in the guidance pages, the Aggregation Escrow Agent will execute, using the Electronic Document Execution process of the system, a Confirmation of Closing document to be delivered to each Participating User listed on the CPC Issuance Schedule and reflecting such data fragments as were included in such schedule (514). In this particular guidance page, the fragment precondition is that the particular Participating User must have remitted the full amount of Funding Proceeds to the Aggregation Escrow Agent as required in fulfillment of the associated Participation Commitment, and, if not satisfied, the Participating User will be excluded from the closing and will not be entitled to the CPCs identified in the CPC Issuance Schedule until such time as that precondition is satisfied or such CPCs may be allocated by the system to another Participating User from which a Participation Commitment had been previously submitted and recorded related to that particular CPC series. Now, the fractionalization process for a Source Credit as administered by the Trustee will be described.

Referring now to FIG. 6, a diagram illustrating an example of the Source Credit fractionalization and issuance process embodiment of a standard credit-based CPC as enabled through the process guidance system is seen. In the present example, the fractionalization process of any Source Credit that complies with the preconditions of the system and the logical construct of the system is described, however, it is envisioned that the guidance pages associated with these process nodes may be applied by those skilled in the art to alternative types of source assets or credits to achieve a similar outcome as those generated by a system and apparatus. Further, the present example illustrates expressly the fractionalization embodiment of the processes. It will be appreciated that for the purposes of the present example, an abbreviated description of the logical construct of the system processes that occur prior to fractionalization are summarized by reference.

It has been previously illustrated that the system accommodates the input of a Source Credit by an Originating User (601) in accordance with certain system preconditions and the input of data via page fragments at a variety of nodes within the logical construct of certain processes constituting a portion of the system as such have been illustrated in detail in FIG. 4 (602). Additionally, the detailed logical construct of certain processes constituting a portion of the system as described in the processes of FIG. 5 constitute preconditions to the fractionalization and CPC issuance process (603), however, the illustration of FIG. 6 solely seeks to define the detailed preconditions, document generation, and guidance process steps to be engaged by the system with the Trustee as referenced under process step 503 as an Administrative User of the system.

Specifically, as a precondition to the electronic execution of the Credit Participation Trust Supplement for the purposes of permitting the custody of a Source Credit by the Trustee under certain predetermined terms and conditions as referenced under process step 503 of FIG. 5, the System Manager will have formed and established (604) a wholly owned bankruptcy remote subsidiary established for the sole purpose of accepting the contribution of Source Credits from the System Manager in accordance with the processes and principles and causing the issuance of CPCs (Master CPC Issuer). As a precondition to any contribution of a Source Credit to the Master CPC issuer, the System Manager will have independently entered into a Contribution Agreement containing certain predetermined terms and conditions as to the method of contribution, which terms and conditions will satisfy and address other preconditions of the specific process steps required for the implementation of the fractionalization processes of the system. The system will provide for the display of page fragments to the System Manager that may include certain preconditions, such as the continuing good standing of the executed Contribution Agreement by and between the System Manager and the Master CPC Issuer. For purposes of example, in the event that the Contribution Agreement were to not be in good standing or in full force and effect, the page fragment may not display to the user, and the guidance page may automatically alter itself to alert the System Manager (as user) of the problem and provide guidance to resolve the problem.

Provided the preconditions were satisfied, the system will display a page fragment to the System Manager related to the Source Credit, wherein the Source Credit being then contributed (605) to the Master CPC Issuer will be automatically populated on a schedule to the Contribution Agreement upon the input of the related credit file reference number of the Source Credit as originally assigned at time of input of such Source Credit by the Originating User, which schedule will be dynamically generated by the system and reflect each Source Credit contribution made in reliance upon the Contribution Agreement since its effective date. Such Schedule is archived by the system in the data repository module as the basis to cumulatively record all Source Credit and related CPC issuances processed, administered, monitored and fractionalized by the system. The page fragment will prompt the System Manager to initial (pursuant to an Electronic Document Execution process) the Source Credit identified on the schedule to the Contribution Agreement as then being contributed, signifying such official contribution by the System Manager. In response, the system will alert and display a page fragment to the Master CPC Issuer requesting the acceptance of such contribution by its initial (pursuant to an Electronic Document Execution process) of the specific Source Credit so contributed.

Upon the electronic execution and acceptance of the initial contribution of a Source Credit that will fractionalize into a specific CPC Class that has not before had a Source Credit processed and CPCs within such CPC Class issued, the system will compile such applicable page fragments as required to generate a CPC Class-specific Credit Participation Trust Agreement for simultaneous presentation and display to the Master CPC Issuer and the Administrative User acting as the Trustee related to a specific Source Credit transaction. Each of these users will cause such agreement to be executed (606) via an application of the Electronic Document Execution software application process of the system, creating the master trust (607) that will govern each trust supplement to be executed by the applicable users within the context of such associated CPC Class for which the Credit Participation Trust Agreement is being executed. Such executed Credit Participation Trust Agreement will be recorded and archived in the data repository module of the system apparatus. The execution and continuing operation of a Credit Participation Trust Agreement for each CPC Class constitutes a system precondition for the generation of each Source Credit-specific Credit Participation Trust Supplement in a related CPC Class as illustrated in FIG. 5, step 503. At the time of system generation of each and any Credit Participation Trust Supplement and its display for execution by the Master CPC Issuer and the Administrative User that has been designated as the Trustee for the related Source Credit to be held in custody/trust, the system will also display to such users a page fragment indicating the preconditioned requirement of the good standing and enforceability of the Credit Participation Trust Agreement to which that particular Credit Participation Trust Supplement solely associates, and additional page fragments requiring certain actions by the user, such as the electronic execution of such supplement provided the aforesaid precondition has been satisfied.

The mutual execution of the Credit Participation Trust Supplement will be recorded and archived in the data repository module of the system (608), and be specifically made a part of the applicable Source Credit File for subsequent on-demand access by users entitled and authorized to access and view such data. The completion of this process step memorializes and evidences the deposit of the Source Credit into the specific segregated trust that has been legally created and established upon the effective date of such particular Credit Participation Trust Supplement (609).

In response to the satisfaction of certain preconditions as further described in step 509 and 512 as illustrated with particularity in FIG. 5, (i) wherein in accordance with the operation of a data aggregation node within the logical construct of the system has generated a Participation Schedule based upon the data fragments contained in each Participating User-specific Participation Commitment as received and input by a Participating User for a specific Source Credit and related CPC series, a Participation Schedule will be displayed and delivered to both the Aggregation Escrow Agent and the Trustee (610) and (ii) wherein a Notice of Closing will be automatically generated by the processes of the system in response to a request therefore from the Aggregation Escrow Agent as such will be executed by the Aggregation Escrow Agent by Electronic Document Execution with an image thereof displayed and delivered to the Trustee of such associated Source Credit transaction (611).

The display and delivery of the Participation Schedule and associated Notice of Closing will be accompanied by specific guidance pages containing page fragments that will establish the Trustee's receipt of both the Participation Schedule and the Notice of Closing as preconditions to be satisfied prior to the Trustee's performance of next required actions within the logical construct of the system as are defined in accompanying page fragments included in this process step. In particular, the system will guide the Trustee through the next process steps of the system, which will consist of (i) an input request from the Trustee for the system generation of a CPC Issuance Schedule (as defined in step 513 of FIG. 5), (ii) the execution of such issuance schedule by the Trustee pursuant to an application of the Electronic Document Execution process, and (iii) the input of such data as included in the CPC Issuance Schedule to the Trustee's designated Register (in the Trustee's capacity as Registrar for the particular CPC series) no later than the closing date prescribed in the Notice of Closing. Such data to be recorded in the Trustee's Register may consist of CPC series identifier, each respective CPC number, the Participating User's name in which the applicable certificate will be issued on the closing date, the face value of each CPC, and such other preconditions as may be identified or specific information as may be required. In one embodiment, the Trustee's Register will be compiled automatically as a process node of the system; however, it may alternatively be administered via an independent software system within the context of the Trustee's server network as may be integrated with the system.

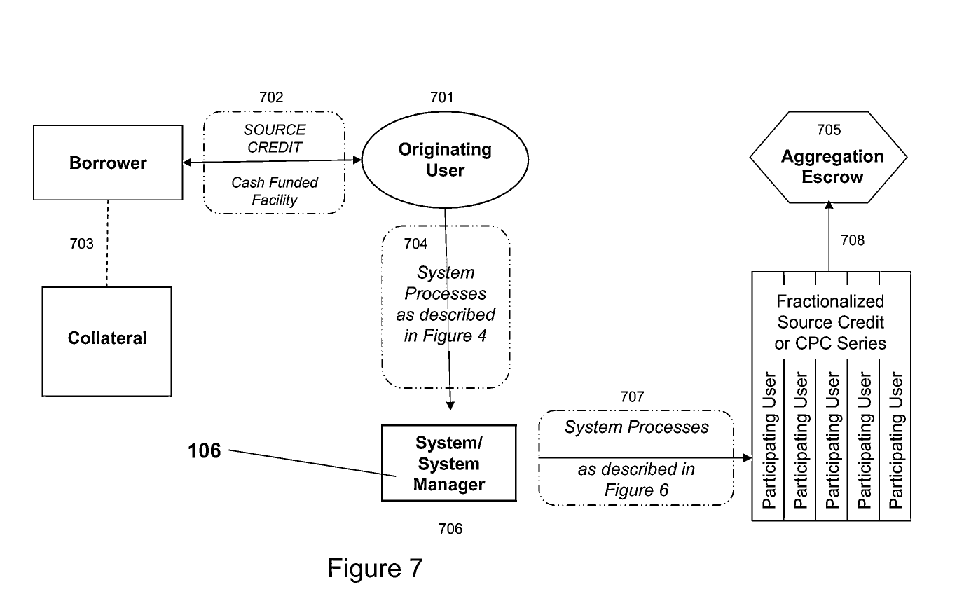

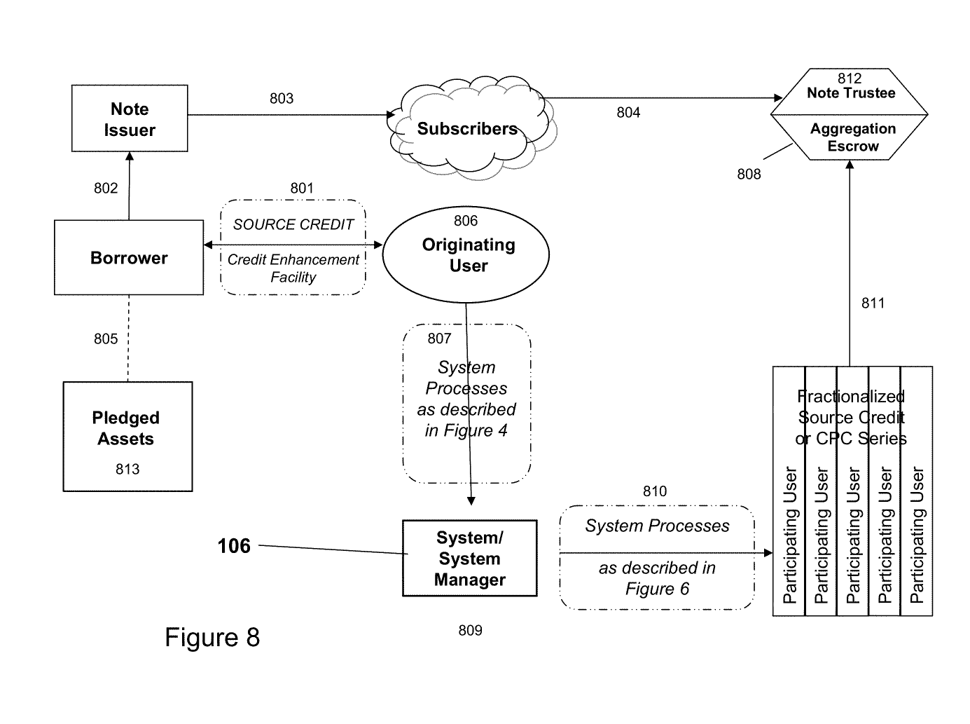

As a predetermination of the fractionalization and CPC issuance process system as intended by the System Manager and implemented, in the one embodiment, the CPCs will be issued (612) on the closing date in book-entry form, wherein upon the Trustee's recordation in its Register and the deposit of the applicable master Participation Certificate (representing all aggregated fractional interests of the Source Credit as will be individually recorded on the Register as beneficial ownership interests of each respective Participating User listed on the Participation Schedule) with the Trustee or such other depository as may be predetermined and established by the System Manager, the CPCs that have been authorized for issuance by the Master CPC Issuer related to a particular Source Credit and resultant from an application of the system are thereby fully issued and in existence. In the event that the System Manager predetermined to issue such CPCs in physical, definitive certificates, the system process may alternatively cause the generation of such certificates resultant from the application of the document generation module as integrated into the logical construct of the system, wherein the Master CPC Issuer would electronically or physically execute such certificates for deposit with the Trustee as Registrar and Custodian for such specific CPC series. Now, for purposes of example of specific types of Source Credits that may be processed and fractionalized in accordance with the processes and their respective related CPC Classes that may be issued resultant from the application of such processes, in FIGS. 7 and 8 the required structural and methodological characteristics of a “funded” Source Credit (Funded Source Credit) and “unfunded” Source Credit (Unfunded Source Credit) type are described.

Referring first to FIG. 7, a diagram illustrating an example of a Funded Source Credit transaction originated pursuant to a preconditioned method and process embodiment compatible with the process guidance system is seen. In the present example, a Source Credit transaction is sited in which an Originating User has identified a commercial borrower (Borrower) that is seeking credit as will be secured by certain collateral (Collateral), both of which—Borrower and Collateral—satisfy certain transactional and structural preconditions of the system. As to the Borrower, although in one embodiment, the Borrower will be a commercial entity, such as a corporation, limited liability company, trust or other commercial operating company, the system may be equally satisfactorily applied in circumstances in which the Borrower may be an individual or otherwise fall under consumer lending practices. Further, in the present example, it is suggested that the Borrower is seeking “credit” for a particular purpose, however, it will be appreciated that, to a professional skilled in the art, the system has the capability to be applied in such a way as to generate the equivalent of an “investment”, as such term customarily applies to equity-like transactions in which an equity interest in the subject recipient of investment proceeds may be taken, with or without the introduction of a debt or credit component to the transaction. Additionally, as to the Collateral, in one embodiment, Collateral may be comprised of single assets, multiple assets of varying credit qualities and natures, multiple assets of homogenous qualities and natures, equity shares of varying characteristics, fund interests or other types of Collateral deemed satisfactory to the Originating User in its capacity as the originator of the Source Credit; provided, however, that such Collateral conforms to such preconditions of the system and System Manager such that it may be administered, monitored, processed and fractionalized in accordance with the system. In light of the foregoing clarifications, this example is not intended to limit the nature of the claims arising from the embodiment of the system, but rather to illustrate a single embodiment of the general nature of the Source Credits suitable for processing through the apparatus of the system.

As a precondition to acting to originate Source Credits in a manner consistent with the logical structure of the process steps, the Originating User will have qualified (701) with the System Manager pursuant to certain preconditions as described in FIG. 2, inclusive of entering into a License Agreement under step 207 which will set forth certain predetermined factors, methods and practices for the origination, identification, implementation and execution of Source Credits that (i) are compatible with the system processes, (ii) satisfy certain minimum predetermined quality control standards, (iii) will specifically manifest upon processing through the system as a specific CPC Class to which the License Agreement particularly applies, and (iv) may be directly derived from the fractionalization of the associated Source Credit so originated. Based upon the determination of the Originating User to grant such Source Credit to the Borrower, the Originating User will present and execute such predetermined forms of documents and Source Credit agreements, inclusive of a Promissory Note and Pledge Agreement in such form as may be specifically called for under the License Agreement. Additionally, as called for under the License Agreement applicable to the nature of certain Source Credits as such are intended to be fractionalized resultant from an application of the system, other agreements and Source Credit preconditions and requirements may be applied by extension of the system requirements to other aspects of the Source Credit, such as, for purposes of example and not limitation, (a) the template of an asset purchase agreement in the event the Borrower is purchasing assets constituting the Collateral as part of the assembly of an aggregated asset portfolio as would be required for a Source Credit fractionalization by application of the processes into an Aggregation CPC, or (b) the template of a specialized collateral servicing and origination agreement in the event that the Borrower is acquiring bank loans constituting the Collateral as part of the assembly of a bank loan portfolio as would be required for a Source Credit fractionalization by application of the processes into a Bank Portfolio CPC. Under the system and apparatus, additional software modules can be introduced to the logical construct of the system processes and features that would be consistent with the system preconditions as defined under each respective License Agreement applicable to a specific CPC Class as derived from a specific nature, credit quality, structural composition, documentary anatomy and methodology of origination of the Source Credits to be processed through the system. In this manner, each Originating User would further benefit from the continuity and efficiency of a logical structure of process steps to the origination of system-compliant Source Credits that represent preconditions to the process guidance system and method as embodied in accordance with the logical construct of the system. It is envisioned that a supplemental series of system processes will be subsequently disclosed as such describe the embodiment of each logical construct of process steps for the origination, sourcing, underwriting, and documentary packaging of each suitable system compatible Source Credit that may be processed and fractionalized through the system to cause the issuance of assorted CPC Classes.

Now, returning to the processes of FIG. 7, in the present example the predetermined documentation representing the Source Credit may be bifurcated into two core components; (1) those executed documents constituting the Source Credit itself (e.g. the Promissory Note and related Pledge Agreement) (702), and (2) the documentation representing and evidencing the Collateral pledged under the Pledge Agreement in support of the Source Credit (e.g. title to Collateral, loan documentation constituting the Collateral, UCC filings or other proofs of lien related to the Collateral, Findings Letters as executed by the designated independent Validation Agent for the Collateral, etc.) (703). The Source Credit will be input and on-boarded for processing, administration, monitoring and fractionalization in accordance with the system pursuant to the processes described in FIG. 4 (704), and, provided the Source Credit satisfies the preconditioned quality control evaluation and other processes defined in FIG. 4, the documentation constituting the Collateral pursuant to the Collateral Schedule related to the Source Credit will be delivered (705) into the custody of the Aggregation Escrow Agent subject to the preconditions of the System Manager's and Aggregation Escrow Agent's executed the Aggregation Escrow Agreement (as described with particularity to a given Source Credit type and specific transaction in process step 502 of FIG. 5).

The balance of process steps described in FIG. 5 (706) and the fractionalization and CPC issuance process steps set forth in FIG. 6 (707), inclusive of the transfer and deposit of cash Funding Proceeds (708) to the Aggregation Escrow Agent on the designated CPC issuance/closing date in consideration of a Participating User's acquisition of a CPC in the Source Credit as held in the custody of the Trustee within the associated trust as created upon from the execution of the applicable Credit Participation Trust Supplement as described in process step 608 of FIG. 6, are thereafter applied and performed in accordance with the guidance pages and page fragments comprising the logical structure of the system. The predetermination of the nature of consideration paid or given by a Participating User for the particular CPC Class derived from a Source Credit upon its fractionalization resultant from the application of the system processes constitutes the basis by which a given CPC Class may be categorized as either a Funded Source Credit or Unfunded Source Credit and the determination of its applicable CPC Class within these two primary categories. Now, an example of the method and processes applied to an Unfunded Source Credit and related CPC series issuance within the context of the system will be described.

Referring next to FIG. 8, a diagram illustrating an example of an Unfunded Source Credit transaction originated pursuant to a preconditioned method and process embodiment compatible with the process guidance system is seen. In the present example, a Source Credit transaction is sited in which an Originating User has identified a Borrower of a comparable profile to that referenced in the example sited under FIG. 7 that is seeking the establishment of a credit enhancement facility constituting the Source Credit (801), wherein the issuance of certain specifically formatted letters of credit (Letter(s) of Credit) will be delivered in accordance with a predetermined construct for the benefit of the Borrower. In this example, the Letter of Credit preferably takes the form of a standby letter of credit, although a professional skilled in the art may elect to use another letter of credit form which becomes payable upon a call for payment by its named beneficiary. As a precondition to the establishment of the credit enhancement facility, the Borrower will have caused or arranged to cause (802) the issuance of certain notes in the form of a CVRDN or, alternatively, a similar VRDN-like or debt instrument (Notes) that will be credit-enhanced by the Letters of Credit and that will conform to such predetermined format, structure and documentary anatomy as required by the system for purposes of enabling the fractionalization of the Source Credit from which the Letters of Credit have been derived. In one embodiment, quality control and standardization as to the nature of the Notes may be achieved pursuant to the entry of a license agreement conforming to such logical structure of process steps that have been predetermined by the System Manager to be compatible with the processes, in particular, the fractionalization of a Source Credit in the form of a credit enhancement facility in order to derive the desired construct of an enhancement-based CPC Class.

For purposes of the present example, it has been proposed that the Borrower has taken such actions as may be required under the Notes to cause the issuance and placement/sale of such Notes (803) with certain qualified Note subscribers as a precondition to the activation or establishment of the Source Credit enhancement facility and any request for issuance of one of more Letters of Credit in relation thereto. In keeping with the predetermined and System Manager-approved processes of the Notes, the proceeds of the sale of such Notes (Note Proceeds) will be deposited in the custody of a trustee or fiscal agent (Note Trustee) (804), wherein they will be held until such time as certain preconditions of the Notes are satisfied, resulting in a conversion of such Notes by way of the substitution of certain predetermined collateral underlying the Notes and the release of Note Proceeds in keeping with the preconditions and requirements of the Source Credit.

In the present example, the Borrower will have identified one or more assets to which it seeks to apply the Note Proceeds (Pledged Assets) (805) and which the Originating User has predetermined will satisfy certain transactional and structural preconditions of the system. Like in the previous “funded” example described in FIG. 7, in one embodiment, Pledged Assets may be comprised of single assets, multiple assets of varying credit qualities and natures, multiple assets of homogenous qualities and natures, equity shares of varying characteristics, fund interests or other types of Pledged Assets that are deemed satisfactory to the Originating User in its capacity as the originator of the Source Credit. Further, and again similar to the previous example, in the present example, it is suggested that the Borrower is seeking a “credit enhancement” for a particular financing purpose, however, it will be appreciated that to a professional skilled in the art, the system has the capability to be applied in such a way as to generate the equivalent of an “investment”, as such term customarily applies to equity-like transactions in which an equity interest in the subject recipient of investment proceeds may be taken, with or without the introduction of a debt or credit component. In light of the foregoing clarifications, this example is not intended to limit the nature of the claims arising from the embodiment of the system, but rather to illustrate a single embodiment of a category of Source Credits suitable for processing through the apparatus of the system that, upon fractionalization, will result in the issuance of one of several possible enhancement-based CPC Classes that are enabled through an application of the system.

As a precondition to acting to originate Source Credits in a manner consistent with the logical structure of the process steps, the Originating User will have qualified (806) with the System Manager pursuant to certain preconditions as described in FIG. 2, inclusive of entering into a License Agreement under step 207 which will set forth certain predetermined factors, methods and practices for the origination, identification, implementation and execution of credit enhancement-based Source Credits that (i) are compatible with the system processes, (ii) satisfy certain minimum predetermined quality control standards, (iii) will specifically manifest upon processing through the system as a specific enhancement-based “unfunded” CPC Class to which the License Agreement particularly applies, and (iv) may be directly derived from the fractionalization of the associated Source Credit so originated. Based upon the determination of the Originating User to grant such Source Credit to the Borrower, the Originating User will present and execute such predetermined forms of documents and Source Credit agreements, inclusive of a Letter of Credit Issuance and Reimbursement Agreement and a Pledge Agreement in such form as may be specifically called for under the License Agreement. Additionally, as called for under the License Agreement applicable to the nature of certain Source Credits as such are intended to be fractionalized resultant from an application of the system, other agreements and Source Credit preconditions and requirements may be applied by extension of the system requirements to other aspects of the Source Credit, such as, for purposes of example and not limitation, (a) the form and nature of all issuance documentation related to the Notes, or (b) the template of an asset purchase agreement in the event the Borrower is utilizing Note Proceeds to purchase assets constituting the Pledged Assets in an aggregated asset portfolio as would be required for a Source Credit fractionalization by application of the processes into an Aggregation Enhancement CPC. As referenced in the description of FIG. 7, under the system and apparatus, additional software modules can be introduced to the logical construct of the system processes and features that would be consistent with the system preconditions as defined under each respective License Agreement applicable to a specific CPC Class as derived from a specific nature, credit quality, structural composition, documentary anatomy and methodology of origination of the Source Credits to be processed through the system. It is anticipated that the application of a logical construct that will guide an Originating User through an increased plurality of steps required to originate and process an Unfunded Source Credit that, when fractionalized, results in the issuance of a form of enhancement-based CPC series would constitute a meaningful supplement to the system application process as described.

Like in FIG. 7, in the present example, the predetermined documentation representing the Source Credit may be bifurcated into two core components; (1) those executed documents constituting the Source Credit itself (e.g. the Letter of Credit Issuance and Reimbursement Agreement and related Pledge Agreement) (702), and (2) the documentation representing and evidencing the Pledged Assets under the Pledge Agreement as such offset any draw under the Source Credit (e.g. title to Pledged Assets, loan documentation constituting the Pledged, share assignments, UCC filings, Findings Letters as executed by the designated independent Validation Agent for the Pledged Assets, etc.). The Source Credit will be input and on-boarded for processing, administration, monitoring and fractionalization in accordance with the system pursuant to the processes described in FIG. 4 (807), and, provided the Source Credit satisfies the preconditioned quality control evaluation and other processes defined in FIG. 4, the documentation constituting the Pledged Assets pursuant to the Collateral Schedule related to the Source Credit will be delivered (808) into the custody of the Aggregation Escrow Agent upon the System Manager's and Aggregation Escrow Agent's electronic execution of the Aggregation Escrow Agreement (both documents as described with particularity to a given Source Credit type and specific transaction in process step 502 of FIG. 5).

The balance of process steps described in FIG. 5 (809) and the fractionalization and CPC issuance process steps set forth in FIG. 6 (810), with the exception of the delivery and deposit of cash Funding Proceeds to the Aggregation Escrow Agent, are illustrated. In the present Unfunded Source Credit and CPC example, in lieu of the transfer of cash Funding Proceeds in payment for a particular Participating User's acquisition of the CPC identified in the Participation Schedule (as described in process step 509 of FIG. 5) on the designated CPC issuance/closing date, in consideration of a Participating User's acquisition of a CPC representing a fractional beneficial ownership in CPC Class that is derived from an Unfunded Source Credit, each Participating User will cause the issuance of a Letter of Credit (811) having a face value equal to the amount of the fractionalized interest in the Source Credit being acquired, which, for the purposes of this example, is also equal to the face value of the CPC to be registered in the name of that particular Participating User. In accordance with the preconditions of the processes constituting the operation of the Notes, upon the receipt by the Aggregation Escrow Agent (which in an embodiment of the system is the same institution as that of the Note Trustee) of each Letter of Credit as such comprises a portion of the aggregate maximum face value of the credit enhancement facility that constitutes the Source Credit in the present example, the Note Proceeds will be released by the Note Trustee (812) in a manner consistent with the preconditions of the Source Credit as defined within the logical construct of the process steps comprising the system and apparatus.

In an embodiment of the example within the context of the processes, each Letter of Credit that has been caused to be issued as payment for a fractional ownership interest in a CPC Class that is derived from an Unfunded Source Credit will be secured by such collateral as may be independently pledged by a respective Participating User to a bank or financial institution of its choosing that may cause the issuance of such Letter of Credit on behalf of such Participating User. Such bank or financial institution that is acting as the Letter of Credit issuer must satisfy certain preconditions for issuance as established within the context of the system, inclusive of maintaining a minimum credit rating on its long-term obligations of at least A1 or equivalent, according to Moody's Investor Services or Standard and Poors. In this embodiment, the Pledged Assets do not constitute Collateral for the Source Credit, but rather are pledged (813) for the benefit of the Originating User and any Participating User that has acquired a direct fractional interest in the enhancement-based Source Credit, whereby, pursuant to the predetermined terms and conditions of such pledge as preconditioned under the system, the Pledged Assets become actionable upon a collection or draw by the Note Trustee under one or more Letters of Credit issued in reliance upon or as part of the operation of the Source Credit. The amounts derived or otherwise recoverable from the Pledged Assets as a result of the maintenance, servicing and collection of the particular Unfunded Source Credit serve as an offset and source of reimbursement of the applicable Participating Users for such collected or drawn amounts. Now, an illustration of Source Credit maintenance and servicing will be described.

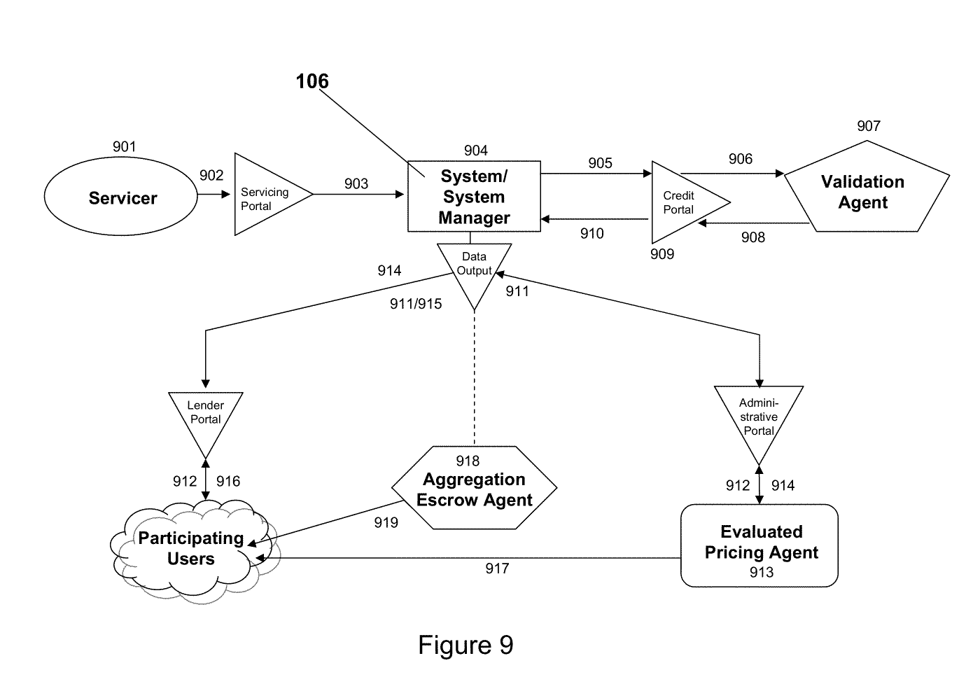

Referring now to FIG. 9, a diagram illustrating the Source Credit and related CPC maintenance, servicing and monitoring embodiment of the process guidance system is seen. In the present illustration, the process for administering and monitoring a Source Credit that has been input and processed utilizing the processes is sited, wherein the logical construct of the system will support the on-going operation of the Source Credit during its complete lifecycle at which time such Source Credit will be reimbursed or otherwise terminated. The apparatus for guiding a user through multiple process steps in the on-going maintenance and administration of a Source Credit, wherein (i) the process steps must be periodically repeated and (ii) the outcome of actions taken, decision matrices applied, or the nature of data input may vary dependent upon the activities of the Source Credit or related Borrower during a particular period of the Source Credit lifecycle is provided that defines an overview of the logical structure of the system based upon a logical construct of steps wherein each process step is represented by a node of the structure and each node is revisited and/or repeated as required upon the initiation of the root node described in this embodiment. Like in the Source Credit on-boarding process, alternatives are presented to the user requiring the user to input responsive data or information or to make a decision. The system also applies its data repository module to permit all responsive data that is recorded as a page fragment to be gathered from related and unrelated users at each respective and applicable node of the present embodiment of the system. Such data and information will be archived and retrieved by the system, wherein such page fragment can be utilized as a precondition to the system generation of servicing reports, the operation of the calculation module, the configuration of guidance pages, the delivery of performance alerts, or the response to other informational requests generated by the system as part of its logical construct for display or access by a user. The processes as described in this diagram commences upon the system's identification and authentication of an Administrative User that satisfies (901) the preconditions of acting as a Source Credit servicing agent to the system (Servicer) upon the utilization of the User Verification Process of the system. In an embodiment of the system, the Servicer would also be acting in the capacity of an Administrative User, Originating User, System Manager or otherwise related to a particular Source Credit, although the Servicer could be designated by either the Originating User or the System Manager as a precondition of the origination of the particular Source Credit prior to input into the system.

In the present example, the Servicer initiates the system process by activating a root node that constitutes the initial process step in the logical structure that initiates the periodic process of Source Credit administration, servicing and monitoring, wherein data is input to the system by the Servicer such that other users may engage in the process at subsequent nodes to access current and near real-time Source Credit data and related system generated reports, and further wherein guidance pages, documents, reports, and statements may be generated by the system in reliance upon data fragments derived from the Servicer's actions at the root node. In this particular system process as such is performed consistently and periodically through the lifecycle of the Source Credit for the benefit of the Participating Users and other interested and authorized parties, the page fragments constituting the Source Credit and related performance details (e.g. timely payment, payment amounts, changes in key personnel, pre-payments, rate resets, etc.) are input (902) by the Servicer via a web-based servicing portal and relied upon in the subsequent construct of guidance pages, documents, reports, and statements as required by the logical structure of the system throughout the balance of the related processes of the present example as well as in other Source Credit related system functions, such as payments, performance report compilation by other Administrative Users, and purchases/remarketing details including recommended pricing functions that are performed by the system during the lifecycle of this Source Credit. At this node, the system will automatically generate (903) a Servicer Document Certification warranting the correctness, truthfulness and accuracy of Servicer inputs related to the Source Credit. The system will require as a precondition to the performance of subsequent process steps by the system and the application of related page fragments to the generation of subsequent documents, inclusive of alerts related to the Source Credit, that the system generated Document Certification be subject to the Electronic Document Execution application of the system.

Upon the completion of the Servicer inputs at the root node of this particular process step of the system, the system will automatically archive and apply (904) a predetermined quality control matrix to the page fragments representing the particular and preconditioned Source Credit details to verify that the data inputs satisfies certain preconditions as to completeness, accuracy, mathematical analysis, predetermined responsive inputs, and consistency with periodic documentary support as uploaded in the form of images in accordance with the process related to a Source Credit. Similar to the functionality of the system as described in FIG. 4, by passing the page fragments through single or multiple nodes representing quality control stations in the logical construct, certain software applications may be applied to the performance of all required structural components of the processes of the present example, such as image recognition technologies for purposes of comparing data contained on pdf or imaged documentation with associated and responsive page fragment data captured by the system, underwriting software containing industry-specific and applicable mathematical formulas, document administration and management software processes to assure completeness of the Source Credit submission when compared to predetermined documentary components of the CPC class to which the Source Credit applies. Predicated upon the satisfaction of the conditions of the quality control check, an alert will be initiated by the system to the Administrative User responsible for monitoring of Source Credit Collateral via electronic mail or other similar communication methods (905). In an embodiment, the particular Administrative User predetermined for the performance of periodic Collateral monitoring and maintenance services during the lifecycle of the Source Credit will be the same Administrative User as performed the validation of the particular Source Credit and verification of the related Collateral as described in process step 406 as described in FIG. 4. The Administrative User will, upon satisfactory completion of the User Verification Process, access the system via a web-based administrative portal and be requested (906) by the system to perform certain predetermined Source Credit evaluative processes as previously established by the System Manager and such Administrative User. This process will call for a periodic and independent verification by the Administrative User of certain page fragments and data inputs archived by the system related to the most recent Servicer inputs pertaining to the subject Source Credit as such has been displayed by the system to such user. The Administrative User will perform (907) such processes as had been predetermined by the System Manager related to the specific class of CPC applicable to the Source Credit upon fractionalization. The nature of validation processes will vary based upon System Manager predeterminations as such comprise a process step in the system, but by way of example and not limitation, scheduled processes may include the independent verification of collateral, operation of continuing security interest, performance claims, and/or market assessment pertaining to the Source Credit. Upon completion of the system prescribed validation processes, the Administrative User will be guided through a process to input (908) information in response to the system's presentation of certain guidance pages reporting on the Administrative User's independent validation findings process as applicable to the associated Source Credit.

The page fragments comprising the findings of the Administrative User will be applied by the system processes to generate (909) a Collateral Level Performance Summary that will be subject to an Electronic Document Execution software application by such Administrative User. Upon execution, the system will contribute (910) an image of the executed Collateral Level Performance Summary to the Source Credit File and issue an alert (911) to (i) the Participating Users then holding CPCs in the Source Credit and (ii) those predetermined Administrative Users that may perform certain evaluated pricing processes of the particular CPC series related to the subject Source Credit as prompted by the system. In both instances, such alert will be delivered in the form of a guidance page that will guide the user through the process of accessing the Source Credit performance data via an appropriate web-based user portal of the system (912) in order to view performance, monitoring and report details.

With specific regard to the delivery of such information to such Administrative User, in accordance with certain predeterminations of the System Manager related to the applicable CPC Class, the designated Administrative User for such purpose will perform (913) such evaluated pricing processes in order to make a finding as to the current daily price of the CPCs in the CPC series related to such Source Credit based upon the performance data derived from the application of the processes. The nature and process to be applied by such Administrative User is outside the purview of system processes, however, upon their completion of the system prescribed processes, the Administrative User will be guided through a process to input (914) CPC pricing information in response to the system's presentation of certain guidance pages reporting on the Administrative User's findings as applicable to the associated CPC series. Upon the input of such pricing data to the system, the system will issue an alert (915) to the Participating Users then holding CPCs in the Source Credit and that have independently subscribed to the services of the particular Administrative User that has generated and input such pricing details to the system, wherein such alert will be delivered in the form of a guidance page that will guide the user through the process of accessing the CPC pricing data via a participating user web-based user portal of the system (916). Alternatively, the Participating Users entitled to such data by rights granted under direct subscription with such Administrative User, may obtain such pricing data directly from such Administrative User, outside the scope and purview of the system process described herein (917).

Concurrent with the operation of the process steps described in 901 to 916 of the present example, dependent upon the anatomy of a specific Source Credit and the behavior of the specific CPC Class to which such Source Credit relates, periodic payments of debt service, yield and collections under the Source Credit will be received (918) for deposit into a predetermined and segregated aggregation escrow account as established by the Aggregation Escrow Agent in accordance with the preconditions of the applicable Aggregation Escrow Agreement as had been executed as described in process step 502 of FIG. 5. The Aggregation Escrow Agent will, as required by the terms and conditions of such particular Aggregation Escrow Agreement as associated with a particular CPC Class, calculates and initiates such payments and distributions as appropriate for the benefit of the Participating Users and other parties entitled thereto based upon the preconditions of a particular transaction (919) by initiating the application of the payments software module as included in the processes of the system. Now, an example of the payment calculation processes of the system as such applies to periodic distribution of yield and other collections will be described.

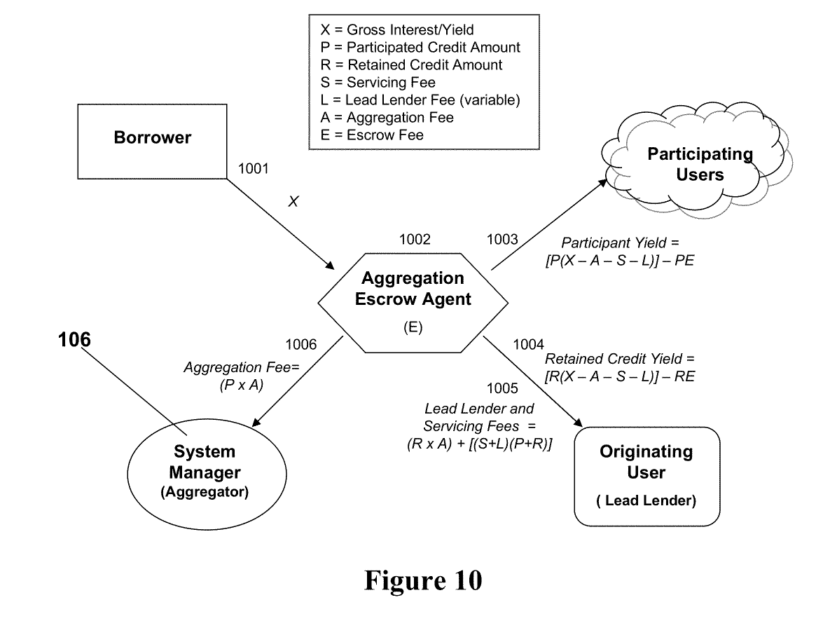

Referring now to FIG. 10, an example of the Source Credit periodic collection, calculation and payment processes and methods embodiment of the process guidance system is seen. In the present example, it has been sited that the root node of this process is initiated upon the making of a payment by a Borrower directly to the aggregation escrow account that has been predetermined by the system as associated to a specific Source Credit and related CPC series. For purposes of referencing certain variations to the processes of the system, it will be appreciated that although illustrated in the example as a direct payment from the Borrower, dependent upon the preconditions of the applicable CPC Class related to a Source Credit, such payment may be made by the Servicer, Originating User or a third party obligor and that the origin of such payment is not relevant to the operation of the processes described in the present example.

Upon the initiation and recording (1001) of a scheduled payment under a Source Credit as further described and referenced in process step 902 of FIG. 9, the Aggregation Escrow Agent will access and apply such calculation node as is incorporated in the logical structure of the system (1002), wherein certain predetermined formulas have been described to reflect the required payments ratios, amounts, fees or other distributions that would be applicable to the CPC Class associated with the subject Source Credit. The standard category of calculation formulas applicable to a CPC Class may be modified by the processes of the system to reflect the specific or special terms and conditions that have been predetermined in accordance with the related Aggregation Escrow Agreement, which preconditions will prevail or govern in the event the payments amounts, calculations or other predetermined formulas derived from such agreement conflict with the standard calculations of the processes of the calculation node of the system of the present example as related to a specific CPC Class.

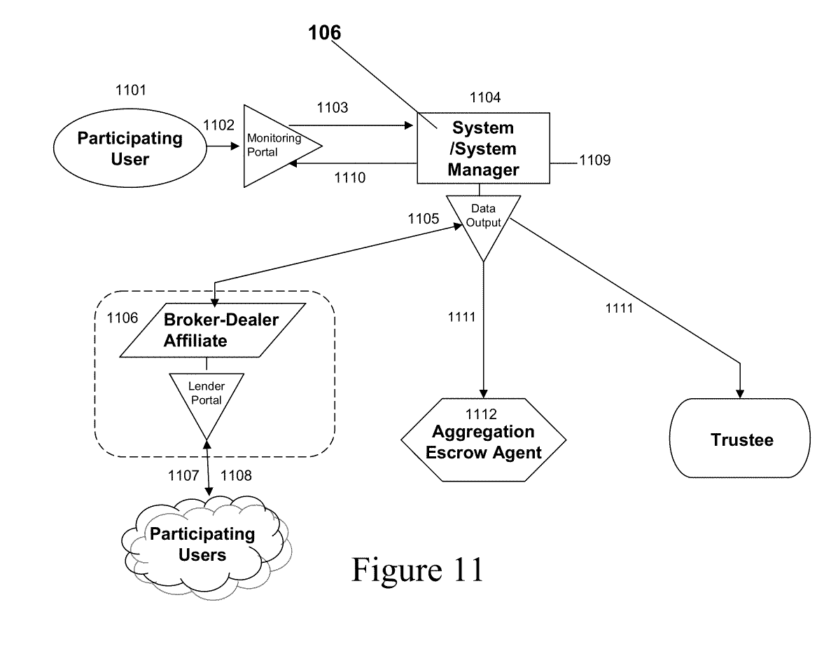

For purposes of illustrating possible formulaic representations as incorporated into the processes of the system, the present example may only apply to such CPC Classes that would have a preconditioned periodic schedule of expected distributions, rather than a total return or “lump sum” collection model. For example, a Commercial CPC related expressly to a Source Credit comprised of a funded commercial loan that would be subject to a periodic debt service model with the Borrower based upon a specific rate of traditional interest, whether amortizing, interest-only or otherwise, wherein debt service payments can be predetermined and scheduled in advance for some period or for the entire lifecycle of the Source Credit. In such event, the logical construct of the system will provide for a system of defined priority of payments to particular entities entitled to such payments in accordance with a calculation process for determination of such amounts. In the present example, the distributions due to the Participating Users in a specific fractionalized Source Credit will be calculated and initiated by the system for the benefit of such Participating Users (1003), taking into account any changes in ownership of the related individual CPCs since the date of closing of the initial CPC purchase transaction (as further described in the processes of FIG. 11) and the date of any such change to data originally recorded by the Trustee in the Register for such CPC series as guided by the system under process step 612 of FIG. 6. In the embodiment, the Trustee will be designated by the Aggregation Escrow Agent in accordance with certain preconditions as the paying agent for the subject CPC series and, as a result, all payments and distributions calculated and initiated within the context of the system for the benefit of such Participating Users as may hold interest in a given CPC series will be affected through the Trustee based upon the calculation and determination of the calculation process of the system.

The calculation processes of the system will also calculate and account for the determination of the distributions due to (i) the Originating User as the originator of the Source Credit in its capacity as a Participating User (1004), wherein the processes of the system precondition the acquisition of a fractional interest in a Source Credit originated by such Originating User be acquired and constituted as a retained interest by such Originating User in the Source Credit so originated (Retained Interest), (ii) the Originating User in its capacity as lead lender and potentially Servicer (1005), and (iii) the System Manager in its capacity as aggregator of the Participating Users within the context of the network of Participating Users established in accordance with the processes as further described in FIG. 3 (1006). In the embodiment, the processes of the system may precondition, based upon a determination of the System Manager or as may be dictated by the characteristics of a particular CPC Class, that a minimum Retained Interest in a particular Source Credit originated by an Originating User be acquired by such Originating User through the purchase of a CPC in the series derived from such related Source Credit. In such manner, an Originating User may also be recorded and identified as a Participating User related to the same Source Credit, and therefore be entitled to the distribution of a plurality of payments in differing professional or user capacities as calculated in accordance with the calculation processes of the system. Likewise, and for the purposes of example and not limitation, an Originating User, when acting as an Administrative User in the professional capacity of Servicer of a Source Credit originated by such Originating User, may also be entitled to a plurality of payments related to the same Source Credit. In any such case, the calculation processes and user recognition application of the system will enable such user to audit amounts paid or payable related to a particular Source Credit by accessing and viewing such payment confirmation pages of the system as such will be comprised of certain related page fragments generated and reflecting calculation, payments and distribution processes of the system. Finally, a description of the CPC remarketing processes as such may impact the calculation of payments due to various Participating Users as holders of an interest in a given CPC series will be described.

Referring now to FIG. 11, a diagram illustrating a system-based CPC remarketing embodiment of the process guidance system is seen. In the present illustration, situation is sited wherein a Participating User will have determined that it wishes to sell an interest in a CPC series and is seeking the consent and assistance of the System manager in the remarketing of such CPC to another Participating User of the system. It should be noted that the processes of the system illustrate a private remarketing or equivalent of a process-managed “over the counter” trade of a CPC interest. In an embodiment of the system, the system will be coordinated with a securities matching, exchange, clearing and settlement software module comprising a system and apparatus that will enable the electronic trading of all CPCs that have been issued and recorded through the application of the processes and method of the system. In such embodiment a liquid CPC marketplace may be enabled as a means to more efficiently price, exchange, trade and acquire CPC as derived from Source Credits processed through the system. However, the development of such a marketplace requires the satisfaction of certain preconditions related to the system, inclusive of but not limited to, a minimum predetermined number of Participating Users and Originating Users being enrolled and registered within the context of the system, a minimum number of Source Credits being input or on-boarded into the system, a minimum number of unitized CPC instruments being issued and held by Participating Users and other such preconditions or benchmark volumes as may be required to enable the efficient utilization and application of such exchange software and systems as an extension of the system.

Prior to the enabled implementation of such an expanded system and in the event a Participating User is seeking or requiring the remarketing of one or more CPCs held, the Participating User will initiate a remarketing request (1101) via a web-based participating user portal, wherein the details of the subject CPC being requested for remarketing will be input into the system (1102), inclusive of the Participating User's Registered Participant Number, the CPC CUSIP or other identifying number, the related File Reference Number, the face amount of the CPC to be remarketed and the target date of resale. The page fragments gathered by the system and representing the relevant CPC data inputs of the Participating User will be compiled by the system via the utilization of a document generation process application of the system. At this node, the system will automatically generate (1103) a document constituting a formal Request for Remarketing and all applicable documents and authorizations to be executed by the Participating User to authorize the transfer of such CPC to a subsequent Participating User as the holder, as such documents may vary per the particular CPC Class being subsequently so transferred. The system will require as a precondition to the performance of subsequent process steps by the system and the application of related page fragments to the generation of subsequent documents that both of these system generated documents be subject to the Electronic Document Execution application of the system and be so executed by the Participating User.

Upon the completion of the Participating User inputs, the system will automatically apply (1104) a predetermined data reconciliation matrix to the page fragments describing the subject CPC to verify that such CPC is currently held by such Participating User and that all data and information describing such CPC corresponds to the data fragments related to such CPC series as recorded in the data repository module of the system. Provided the processes of the system determines that such CPC is valid and therefore eligible for remarketing, a Remarketing Summary and Alert that describes the particular CPC instrument that is being remarketed will be generated by the system and will contain a fragment precondition to display (1105) only to those Participating Users that are qualified to receive such information pursuant to system credentials. Such document will be comprised of multiple page fragments, wherein those fragments are assembled in such a way as to subscribe to a standard format reflective of such characteristics as is appropriate for such CPC Class. In an embodiment, the CPC instrument data will be delivered via a participating user portal that is owned by a duly registered, regulated and/or licensed entity (1106) having such professional credentials as may be required to permit the offering or solicitation for sale of securities in a form consistent with the CPC.

Based upon a review of the system data via guidance pages containing the applicable CPC series data points, a decision will be requested of each Participating User (e.g. to participate or not to participate in the subject transaction) and each Participating User will input data and its decision (1107) via the participating user portal for capture by system. In the present example, we are illustrating a decision taken and input as a page fragment by a Participating User to acquire the particular CPC being remarketed by an application of the described processes of the system. As such, the page fragments and data inputs gathered by the system through the participating user portal will be coordinated (1108) by the system into a Purchase Commitment that will be subject to Electronic Document Execution by the Participating User and deposited to the system's data repository module. An image of the electronically executed Purchase Commitment will be deposited to the Source Credit File in the system data repository (1109).

The System Manager will execute via the Electronic Document Execution process, its consent to transfer of such particular CPC as such was included in the documentation generated and delivered to the System Manager at process step 1103 and deliver such to the Participating User that has requested the remarketing (1110). Concurrently, the system will generate an alert to be delivered (1111) to the Aggregation Escrow Agent and the Trustee acting with reference to the particular CPC series of which the CPC being remarketed is a part. The display and delivery of the respective alert identified will be accompanied by specific guidance pages that will identify the next action required by each such Administrative User (in their respective capacities related to the subject CPC series), if any, related to the remarketing processes of the system. Specifically, (a) in the case of the Aggregation Escrow Agent, the amount and date of remarketing and, in the event the Aggregation Escrow Agent is to receive the remarketing proceeds for subsequent disbursement to the Participating User that has requested the remarketing of its CPC, the funds transfer instruction applicable thereto, and (b) in the case of the Trustee, a page fragment instructing the recording of such data and information related to the CPC as is customarily recorded in the register of an institution acting as Registrar for a security series. In the present process example, the Aggregation Escrow Agent will process and disburse, pursuant to the details described in the page fragments delivered via the system, the distribution of remarketing proceeds to the Participating User for whom the remarketing process of the system was applied, however, alternatively, remarketing settlement could be processed outside the purview of the Aggregation Escrow Agent provided such data and information was provided to the system via a participating user portal and such data was verified pursuant to a preconditioned system process.

While the invention has been described with specific embodiments, other alternatives, modifications and variations will be apparent to those skilled in the art. For example, although the Source Credits are described as “credit”, by modifying the yield or repayment schedule related to such credit or any credit enhancement feature that may be employed in the transaction or, alternatively or additionally, permitting equity shares to be pledged as collateral for a Source Credit under certain circumstances, a system can be applied to create a credit-based surrogate for what in most material respects would customarily be structured as an equity investment having performance-based yields or return models embodied in the structure. Accordingly, it will be intended to include all such alternatives, modifications and variations set forth within the spirit and scope of the appended claims.

1. A system for administering the issuance and offering of credit participation certificates constituting fractional ownership interests in a source credit by an originating user to a plurality of participating users, the system comprising:
a computer-based central process guidance unit;
one or more originating user portals capable of being connected to the central process guidance unit by a link;
one or more participating user portals capable of being connected to the central process guidance unit by a link;
one or more administrative user portals capable of being connected to the central process guidance unit by a link;
an authentication unit of the process guidance unit that authenticates a source credit from an originating user;
the process guidance unit that assembles, sets up and closes a fractionalized source credit offering based on the authenticated and verified source credit from the originating user;
one or more participating user portals that display the offering to each participating user who is authorized to view the offering and receive a decision by one or more participating users to acquire a fractional interest in the source credit; and
the process guidance unit that fractionalizes the source credit and generates the credit participation certificates that are distributed to the one or more participating users.

2. The system of claim 1, wherein the authentication unit qualifies an originating user to provide a new source credit to the system.

3. The system of claim 2, wherein the authentication unit generates one or more page fragments to a display of an originating user portal, receives originating user responses to the one or more page fragments and authenticates the originating user.

4. The system of claim 3, wherein the authentication unit dynamically generates a page fragment based on the user responses.

5. The system of claim 1, wherein the authentication unit qualifies a participating user to participate in the credit participation certificates offered by the system.

6. The system of claim 5, wherein the authentication unit generates one or more page fragments to a display of a participating user portal, receives participating user responses to the one or more page fragments and authenticates the participating user.

7. The system of claim 6, wherein the authentication unit dynamically generates a page fragment based on the user responses.

8. The system of claim 1 further comprising a quality control unit of the process guidance unit that compares input source credit data from an originating user against a standard protocol associated with the particular type of credit participation certificate to be derived from such source credit.

9. The system of claim 1 further comprising a data verification unit of the process guidance unit that incorporates and coordinates both automated and semi-automated processes to be implemented by administrative users to verify representations made by the originating user with regard to a source credit.

10. The system claim 8, wherein the quality control unit compares source credit data to predetermined data points, source credit characteristics, and origination requirements of each type of credit participation certificate that is capable of being processed through the system.

11. The system of claim 1, wherein the credit participation certificate is one of a state receivables CPC, a government receivables CPC, a trade receivables CPC, an ABIC, a commercial CPC, a commercial enhancement CPC, a bank portfolio CPC, a portfolio enhancement CPC, an aggregation CPC, an aggregation enhancement CPC, a private equity CPC, a CPCPC, a fund enhancement CPC, a special enhancement CPC, a mezz CPC, a flex CPC, a mezz enhancement CPC, or a fractional source credit instrument as may be derived from the application of the system of fractionalizing a single source credit as held in a trust.

12. The system of claim 1, wherein the process guidance unit assigns an administrative user as a trustee for the administration of the fractionalized source credit and assigns an administrative user as an aggregation escrow agent for the administration of payments and debt servicing under the source credit and the custody and management of its supporting collateral.

13. The system of claim 12, wherein the process guidance unit charges the trustee with the administration of a fixed investment trust that custodies the source credit being fractionalized as a static asset of a trust.

14. The system of claim 13, wherein the credit participation certificates constitute fractional ownership interests in such fixed investment trust.

15. The system of claim 14, wherein the trustee will act as registrar, transfer agent, and paying agent for the credit participation certificates.

16. The system of claim 12, wherein the process guidance unit allows the aggregation escrow agent to custody and maintain the collateral for the source credit.

17. The system of claim 16, wherein the process guidance unit allows the aggregation escrow agent to collect and pay amounts related to the source credit based on the terms of an aggregation escrow agreement generated by the system and executed by the system manager.

18. The system of claim 17, wherein the process guidance unit allows the originating user to monitor the status of collateral being managed or otherwise substituted in support of the source credit and input such data into the process guidance unit.

19. The system of claim 12, wherein the process guidance unit generates limited instructions from the system manager to the aggregation escrow agent in the form of page fragments based upon system inputs from the related originating user during the lifecycle of a source credit.

20. The system of claim 19, wherein the aggregation escrow agent, as an administrative user, may dynamically manage the collateral based upon such system-generated instructions.

21. The system of claim 12, wherein the one or more administrative user portals display, to one of the trustee and the aggregation escrow agent, a participation schedule for the one or more participating users that decided to acquire a fractional interest in the source credit.

22. The system of claim 1, wherein the process guidance unit assigns an administrative user as a validation agent for purposes of verifying certain data inputs by an originating user related to a source credit as a part of the data verification unit of the system.

23. The system of claim 22, wherein the data verification unit performs, by the validation agent a source credit validation process and produces certain independent findings letters and reports in support of the status of source credit collateral held in the custody of the aggregation escrow agent.

24. The system of claim 1, wherein the process guidance unit receives a new source credit from an originating user.

25. The system of claim 24, wherein the process guidance unit receives information about the new source credit using one or more guidance pages and automatically generates one or more documents in response to the new source credit information.

26. The system of claim 24, wherein the authentication unit authenticates an originating user of the new source credit, receives information about the new source credit, and issues an originator document certificate based on the new source credit information.

27. The system of claim 24 further comprising a quality control unit of the process guidance unit that compares input source credit data from an originating user against a standard protocol associated with the particular type of credit participation certificate to be derived from such source credit, wherein the quality control unit performs certain page fragment comparisons to predetermined quality control features of the system related to specific types of source credits and related credit participation certificates and issues alerts to the system manager and other administrative users of any deviations in source data inputs from the originating user.

28. The system of claim 24 further comprising a data verification unit of the process guidance unit that incorporates and coordinates both automated and semi-automated processes to be implemented by administrative users to verify representations made by the originating user with regard to a source credit, wherein the data verification unit performs, by an administrative user, a source credit validation process.

29. The system of claim 1, wherein each portal is a computing device having a processing unit, a memory connected to the processing unit and a display.

30. The system of claim 29, wherein each computing device is a personal computer, a tablet computer, smartphone device, a terminal and a cellular phone.

31. The system of claim 1, wherein the source credit is one of a funded source credit or an unfunded source credit.

32. The system of claim 1, wherein the process guidance unit remarkets a CPC for a participating user.

33. A computer implemented method for administering the issuance and offering of credit participation certificates constituting fractional ownership interests in a source credit by an originating user to a plurality of participating users, the method comprising:
authenticating and verifying, by a computer implemented process guidance system, a source credit input to the system via an originating user portal by an originating user;
assembling, setting up the issuance and closing, by the process guidance system, a fractionalized source credit offering based on the authenticated and verified source credit from the originating user;
displaying, on a participating user portal for each participating user, the offering to each participating user who is authorized to view of the offering;
receiving a decision, by one or more participating users on one or more participating user portals, to acquire a fractional interest in the source credit; and
fractionalizing, by the process guidance system, the source credit and generating the credit participation certificates that are distributed to the one or more participating users.

34. The method of claim 33 further comprising qualifying an originating user to provide a new source credit to the system.

35. The method of claim 34, wherein qualifying the originating user further comprises generating one or more page fragments to a display of an originating user portal, receiving originating user responses to the one or more page fragments and authenticating the originating user.

36. The method of claim 35, wherein generating one or more page fragments further comprises dynamically generating a page fragment based on the user responses.

37. The method of claim 33 further comprising qualifying a participating user to participate in the credit participation certificates offered by the system.

38. The method of claim 37, wherein qualifying the participating user further comprises generating one or more page fragments to a display of a participating user portal, receiving originating user responses to the one or more page fragments and authenticating the participating user.

39. The method of claim 38, wherein generating one or more page fragments further comprises dynamically generating a page fragment based on the user responses.

40. The method of claim 33, wherein assembling the fractionalized source credit based on the authenticated source credit from the originating user further comprising assigning an administrative user as a trustee for the fractionalized source credit.

41. The method of claim 33, wherein assembling the fractionalized source credit based on the authenticated source credit from the originating user further comprising assigning an administrative user as an aggregation escrow agent for the fractionalized source credit.

42. The method of claim 41, wherein assembling the fractionalized source credit based on the authenticated source credit from the originating user further comprising assigning an administrative user as a validation agent for the collateral of the source credit.

43. The method of claim 33, wherein the credit participation certificate is one of a state receivables CPC, a government receivables CPC, a trade receivables CPC, an ABIC, a commercial CPC, a commercial enhancement CPC, a bank portfolio CPC, a portfolio enhancement CPC, an aggregation CPC, an aggregation enhancement CPC, a private equity CPC, a CPCPC, a fund enhancement CPC, a special enhancement CPC, a mezz CPC, a flex CPC, a mezz enhancement CPC, or a fractional source credit instrument as may be derived from the application of the system of fractionalizing a single source credit as held in a fixed trust as secured by a dynamic set of collateral held in a separately administered escrow.

44. The method of claim 40 further comprising displaying, to one of the trustee and the aggregation escrow agent, a participation schedule for the one or more participating users that decided to acquire a fractional interest in the source credit.

45. The method of claim 33 further comprising receiving, by the process guidance system, a new source credit from an originating user.

46. The method of claim 45, wherein receiving a new source credit further comprises receiving information about the new source credit using one or more guidance pages and automatically generating one or more documents in response to the new source credit information.

47. The method of claim 45, wherein receiving a new source credit further comprises authenticating an originating user of the new source credit, receiving information about the new source credit, issuing an originator document certificate based on the new source credit information and performing, by an administrative user, a source credit validation process.

48. The method of claim 33, wherein the source credit is one of a funded source credit or an unfunded source credit.

49. The method of 40 further comprising maintaining the register of credit participation certificates, and acting as transfer agent and paying agent for participating users that have decided to acquire fractional interests through the system.

50. The method of claim 41 further comprising administering the source credit and maintaining the collateral for the source credit by the aggregation escrow agent.

51. The method of claim 41 further comprising collecting and paying based on the source credit by the aggregation escrow agent

52. The method of claim 33 further comprising remarketing, by the process guidance unit, a CPC for a participating user.

53. The method of claim 33 further comprising comparing, using a quality control unit of the process guidance unit, input source credit data from an originating user against a standard protocol associated with the particular type of credit participation certificate to be derived from such source credit.

54. The method of claim 33 further comprising verifying, by a data verification unit of the process guidance unit, representations made by the originating user with regard to a source credit.
